(19) United States
(12) Patent Application Publication
(10) Pub. No.: US 2026/0310944 A1
(43) Pub. Date: Oct. 8, 2026

(54) COMPLETE HUMAN-IN-THE-LOOP AGENTIC AI SYSTEM FOR CHURN PREDICTION AND IN-TIME RETENTION PLANNING AND EXECUTION

(71) Applicant: ChurnShift Inc., New York, NY (US)

(72) Inventor: Rouzbeh Farahmand, New York, NY (US)

(21) Appl. No.: 19/638,304

(22) Filed: Apr. 3, 2026

Related U.S. Application Data
(60) Provisional application No. 63/783,502, filed on Apr. 4, 2025.

(51) Int. Cl. G06N 3/0475; G06N 3/092

(52) U.S. Cl. CPC G06N 3/0475; G06N 3/092

(57) ABSTRACT

A computer-implemented method for customer retention uses an agentic artificial intelligence pipeline comprising an orchestration layer that coordinates a plurality of specialized AI agents via a schema-validated inter-agent communication protocol. Customer data may be collected and processed through the AI agents. A custom churn modeling agent may automatically select and train a machine learning algorithm and generate local and global explanations for each churn prediction. Survival analysis techniques, including Kaplan-Meier estimators, may estimate when each at-risk customer is likely to churn. A Bayesian Network may be constructed to identify probable churn causes and map them to corresponding retention treatments. A Large Language Model agent conditioned on the identified causes and treatments may generate personalized retention communications. Retention recommendations may be presented to a human operator for approval prior to implementation. Observed retention outcomes may be used to update Bayesian Network conditional probability distributions to improve future recommendations.

### RELATED APPLICATION

Under provisions of 35 U.S.C. § 119(e), the Applicant claims benefit of U.S. Provisional Application No. 63/783,502 filed on Apr. 4, 2025, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure relates generally to computer systems, and more particularly to artificial intelligence systems for customer retention.

### BACKGROUND

Customer retention refers to the ability of a company to retain its customers over a specified period. Customer churn, conversely, is the loss of clients or customers. High churn rates may indicate customer dissatisfaction and can significantly affect company revenue.

Churn analysis, also known as customer attrition detection, is a well-known problem in business analytics. Various methods have been developed to address this problem. Most existing technologies and solutions relate to churn prediction, which involves predicting which customers are likely to cancel their services or subscriptions.

Conventional approaches typically involve custom-built solutions using rule-based and/or data-driven machine learning methods. These approaches often train machine learning classifiers to predict whether a customer will churn or not, essentially implementing binary classification.

Current methods face several limitations. Many churn prediction solutions are custom-built for specific companies or industry verticals. Given that most current machine learning methods require substantial data, they may not perform optimally with smaller datasets typical of small and medium-sized businesses (SMBs).

Additionally, most existing systems merely predict which customers might churn without providing comprehensive explanations as to why. Furthermore, many SMBs lack in-house data science teams and face a shortage of economically viable off-the-shelf solutions that can create customer retention plans tailored to their specific business and data.

Finally, there is a lack of automated or semi-automated systems that can recommend actions with human oversight to retain customers predicted to churn.

From a technical standpoint, existing churn prediction systems may lack a structured mechanism for coordinating multiple specialized AI agents through a validated inter-agent communication protocol, resulting in brittle pipelines that may fail silently when data formats change between processing stages. Existing systems may also lack a closed-loop mechanism for updating probabilistic cause-to-treatment models based on observed retention outcomes, requiring manual retraining and redeployment to incorporate new outcome data. These technical deficiencies may result in increased pipeline failure rates, degraded model accuracy over time, and increased latency between churn detection and retention action delivery.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Systems and methods for customer retention through an agentic artificial intelligence system are described herein. In some embodiments, a computer-implemented method may include: collecting and processing customer data through specialized artificial intelligence (AI) agents; predicting which customers are likely to churn using a custom churn modeling agent; analyzing when identified customers are likely to churn using survival analysis techniques; determining causes of potential churn through differential diagnosis; generating personalized retention strategies through AI agents; presenting retention recommendations for human verification; implementing approved retention actions; and monitoring customer responses to update retention strategies.

In one aspect, a computer-implemented method for improving customer retention through an agentic artificial intelligence pipeline that reduces manual data science overhead, increases churn prediction accuracy through automated algorithm selection and cross-validated model evaluation, and generates personalized retention communications without human authoring is provided, wherein the method includes collecting and processing customer data through a plurality of specialized artificial intelligence (AI) agents operating under an orchestration layer that coordinates inter-agent communication via a structured data protocol. The method further includes predicting which customers are likely to churn by executing a custom churn modeling agent that automatically selects a machine learning algorithm based on data characteristics, trains the selected algorithm with automatic hyperparameter tuning, and generates local and global explanations for each churn prediction. The method further includes estimating a churn timeline for each identified at-risk customer by applying survival analysis techniques, including Kaplan-Meier estimators, to predict when each customer is likely to churn. The method further includes determining causes of potential churn for each at-risk customer through a differential diagnosis process comprising constructing a Bayesian Network representing probabilistic relationships between churn causes and retention treatments, identifying probable causes of churn for the individual customer, and mapping the identified causes to corresponding retention treatments. The method further includes generating personalized retention communications and incentives through a Large Language Model agent conditioned on the identified churn causes and mapped treatments. The method further includes presenting the generated retention recommendations to a human operator for verification prior to implementation. The method further includes implementing only the retention actions approved by the human operator. The method further includes monitoring customer responses to implemented retention actions and updating the Bayesian Network based on observed outcomes to improve future retention recommendations.

In another aspect, a system for customer retention through agentic artificial intelligence is provided, wherein the system includes an orchestration layer configured to activate, coordinate, and monitor a plurality of specialized AI agents via a structured inter-agent communication protocol. The system further includes a data processing subsystem comprising AI agents configured to collect customer data from multiple sources, transform the collected data for analysis, and validate data quality through automated quality tests. The system further includes a churn prediction subsystem comprising AI agents configured to automatically select and train machine learning models for churn prediction and generate local and global explanations for each prediction. The system further includes a churn timeline subsystem comprising AI agents configured to apply survival analysis techniques, including Kaplan-Meier estimators, to estimate when each at-risk customer is likely to churn. The system further includes a retention planning subsystem comprising AI agents configured to construct Bayesian Networks representing probabilistic relationships between churn causes and retention treatments, identify probable churn causes for individual customers, and map identified causes to corresponding treatments. The system further includes a customer interaction subsystem comprising a Large Language Model agent configured to generate personalized retention communications and incentives conditioned on identified churn causes and mapped treatments. The system further includes a human verification interface configured to present retention recommendations to a human operator for approval prior to implementation. The system further includes a persistence subsystem comprising AI agents configured to store churn prediction data and models, issue alerts for imminent churn risks, and update the Bayesian Networks based on observed retention outcomes.

In yet another aspect, a non-transitory computer-readable storage medium storing instructions that, when executed by a computing system, cause the computing system to perform operations of an agentic artificial intelligence pipeline comprising an orchestration layer that coordinates a plurality of specialized AI agents via a schema-validated inter-agent communication protocol is provided, wherein the operations include collecting and processing customer data through specialized artificial intelligence (AI) agents. The operations further include predicting which customers are likely to churn and when using custom modeling agents. The operations further include determining causes of potential churn and appropriate treatments through differential diagnosis using a Bayesian Network. The operations further include generating personalized retention communications through a Large Language Model agent conditioned on identified churn causes and mapped treatments. The operations further include presenting retention recommendations for human verification and receiving operator approval, modification, or rejection of each recommendation prior to implementation. The operations further include implementing only approved retention actions. The operations further include updating Bayesian Network conditional probability distributions based on observed retention outcomes to improve future retention recommendations.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a data flow diagram of an AI agent ensemble for Phase 1 of the customer retention system, in accordance with some embodiments.

FIG. 2 illustrates a data flow diagram of an AI agent ensemble for Phase 2 of the customer retention system, in accordance with some embodiments.

FIG. 3 illustrates a data flow diagram of an AI agent ensemble for Phase 3 of the customer retention system, in accordance with some embodiments.

FIG. 4 is a flowchart of a computer-implemented method for improving customer retention through an agentic artificial intelligence pipeline that reduces manual data science overhead, increases churn prediction accuracy through automated algorithm selection and cross-validated model evaluation, and generates personalized retention communications without human authoring.

FIG. 5 is a block diagram of a system including a computing device for orchestrating a human-in-the-loop agentic AI system for churn prediction and in-time retention planning and execution.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

A technical problem exists in the field of customer retention, where businesses face challenges in identifying, understanding, and addressing customer churn. Customer churn, which refers to the loss of clients or customers, may significantly impact business revenue and growth. Traditional approaches to customer retention may lack precision in predicting which customers are likely to leave, when they might leave, and what actions could effectively prevent their departure. This problem may be particularly acute for small and medium-sized businesses (SMBs) that may not possess extensive data science resources or large customer datasets.

The present approach may address these technical challenges through a comprehensive system that integrates specialized artificial intelligence (AI) agents to predict customer churn, analyze churn timelines, diagnose churn causes, and recommend personalized retention strategies. The system may be implemented as a cloud-based Software as a Service (SaaS) architecture with interconnected AI agents that operate in three distinct phases.

The agentic pipeline may reduce manual data science overhead by automating tasks that would otherwise require human data scientists, including data preprocessing, algorithm selection, hyperparameter tuning, model evaluation, and explainability report generation. In conventional churn prediction workflows, each of these tasks may require manual configuration, iterative experimentation, and domain expertise. The present system may perform each of these tasks autonomously through specialized AI agents, reducing the time and personnel required to deploy a functional churn prediction model. The system may further generate personalized retention communications autonomously through a Large Language Model agent without requiring human authoring of individual messages. The LLM agent may produce a complete, channel-formatted retention communication for each at-risk customer based on structured inputs comprising the customer's churn cause, mapped treatment, and engagement history, without requiring a human to compose or edit the message prior to the human verification step. The human verification step may allow a human operator to approve, modify, or reject the generated communication, but does not require the human to author the communication from scratch.

In a conventional manual churn prediction workflow, a data scientist may spend multiple days or weeks performing data collection, cleaning, and feature engineering; selecting and evaluating candidate machine learning algorithms through manual experimentation; tuning hyperparameters through iterative trial-and-error; and generating explanation reports through separate post-hoc analysis tools. Each of these tasks may require domain expertise, manual configuration, and iterative review cycles before a deployable model is produced. The present system may automate each of these tasks through specialized AI agents operating under the orchestration layer, reducing the time from data ingestion to deployed churn prediction model from days or weeks to a single automated pipeline execution. For small and medium-sized businesses that may lack dedicated data science personnel, this reduction in manual overhead may enable deployment of a functional churn prediction and retention pipeline without requiring in-house data science expertise.

In one example implementation, the system may be applied to a subscription-based software company experiencing elevated customer churn rates. The company may have limited internal data science capabilities and may struggle to identify which customers are at risk of canceling their subscriptions. By implementing the present approach, the company may collect and process customer usage data, billing information, support interactions, and feedback through specialized AI agents. The system may then predict which customers are likely to cancel their subscriptions, estimate when these cancellations might occur, and recommend targeted retention strategies such as personalized discount offers or product feature enhancements.

In another example, the system may be utilized by a telecommunications provider to address customer churn in their mobile service offerings. The telecommunications provider may have a large customer base but may lack effective methods for proactively identifying and retaining at-risk customers. Through the implementation of the present approach, the provider may analyze customer call patterns, billing data, network usage, and customer service interactions. The AI agents may identify customers showing early signs of potential churn, predict their likelihood of switching to competitors, and recommend timely interventions such as service upgrades or targeted communication strategies.

In yet another example, an e-commerce retailer may employ the system to maintain customer loyalty and prevent churn in their repeat customer base. The retailer may collect and process customer purchase history, browsing behavior, cart abandonment data, and customer reviews through the data collection and processing agents. The churn prediction agents may identify customers whose purchasing frequency may be declining or who may be showing other indicators of reduced engagement. The system may then analyze when these customers might completely disengage and recommend personalized retention strategies such as exclusive offers or personalized product recommendations based on the diagnosed causes of their potential churn.

In a healthcare context, a medical subscription service may utilize the system to retain patients enrolled in their preventive care programs. The service may analyze patient appointment attendance, engagement with health resources, and satisfaction surveys through the AI agents. The system may identify patients who may be at risk of discontinuing their care plans, predict when they might do so, and recommend personalized interventions such as educational content about health benefits or modified care schedules based on the diagnosed causes of potential disengagement.

The system may operate through a structured three-phase process. In the first phase, the system may focus on identifying which customers are likely to churn. This phase may involve data collection, processing, and quality testing through specialized AI agents. An automatic custom churn modeling agent may select appropriate machine learning algorithms based on the specific characteristics of the available data and may train these algorithms with automatic hyperparameter tuning. An explainability agent may generate both local and global explanations for the churn predictions, providing insights into why specific customers may be at risk and identifying broader patterns in customer behavior.

In the second phase, the system may analyze when identified at-risk customers are likely to churn. This phase may apply survival analysis techniques borrowed from the medical field, utilizing Kaplan-Meier estimators to predict customer churn timelines. This approach may help businesses prioritize their retention efforts by focusing on customers who may be at imminent risk of churning.

In the third phase, the system may determine how to retain at-risk customers through a differential diagnosis approach. This phase may involve constructing Bayesian Networks that represent the probabilistic relationships between churn causes (symptoms) and potential retention strategies (treatments). A customer differential diagnosis agent may identify probable causes of churn for individual customers, while a treatment prescriber agent may map these causes to appropriate retention actions. A customer interaction recommender agent may then generate personalized communications and incentives using a specialized Large Language Model (LLM) and cost-effective Small Language Model (SLM).

Throughout all phases, the system may incorporate human oversight through a human-in-the-loop verification process. Retention recommendations may be presented to human operators for approval before implementation, ensuring that the automated suggestions align with business objectives and brand values. The system may also continuously monitor customer responses to retention efforts and update its strategies based on observed outcomes.

The human verification interface may present retention recommendations to a human operator through a dashboard or review queue. For each at-risk customer, the interface may display the customer's predicted churn probability score, estimated churn timeline, identified churn cause categories ranked by posterior probability, and the proposed retention action including the generated personalized communication and incentive. The operator may take one of three actions for each recommendation: approve, modify, or reject. If the operator approves a recommendation, the system may route the approved communication to the designated delivery channel for transmission to the customer. If the operator modifies a recommendation, the interface may allow the operator to edit the communication text, adjust the incentive type or value, or change the delivery channel, after which the modified recommendation may be submitted for delivery. If the operator rejects a recommendation, the system may log the rejection with an optional reason code and may flag the customer record for manual follow-up or re-evaluation in a subsequent diagnostic cycle. The interface may also allow the operator to set a bulk approval threshold, whereby recommendations with a churn probability score above a configurable threshold and a composite urgency score above a configurable minimum may be automatically approved without individual review, subject to operator configuration.

The present approach may produce measurable technical improvements over conventional churn prediction systems. By generating a custom and model training plan based on customer data and business domain including selecting the proper training algorithms and evaluation techniques from well-known machine learning techniques, the system may reduce the manual overhead associated with manual data scientific work. Additionally, the custom modeling and training plans can iterate over a variety of methods and may achieve higher predictive accuracy on small and imbalanced datasets than single-algorithm approaches. The closed-loop Bayesian Network update mechanism, which recomputes conditional probability tables from observed retention outcomes using a configurable learning rate, may improve the precision of cause-to-treatment mappings over successive pipeline executions, reducing the rate of ineffective retention interventions over time. The human verification interface, by presenting ranked recommendations with approve, modify, and reject controls, may reduce the volume of erroneous retention actions transmitted to customers while preserving operator efficiency through configurable bulk-approval thresholds.

The system may offer several advantages over existing approaches to customer retention:
Cost-effectiveness: The system may be accessible to SMBs that lack in-house data science teams, providing advanced analytics capabilities without requiring significant investment in personnel or infrastructure.
Customization: The system may adapt to companies with limited datasets, using techniques appropriate for the available data rather than requiring massive data volumes.
End-to-end solution: The system may provide a complete solution from churn prediction to retention implementation, rather than addressing only isolated aspects of the customer retention problem.
Actionable recommendations: The system may go beyond mere churn prediction to provide specific, personalized retention strategies with human oversight.
Explainability: The system may provide clear explanations of churn predictions and retention recommendations, enabling businesses to understand and trust the system's outputs.
Human-in-the-loop design: The system may incorporate human verification and approval at key points, combining the efficiency of automation with human judgment and expertise.

The present disclosure includes many aspects and features. Moreover, while many aspects and features relate to, and are described in, the context of a human-in-the-loop agentic AI system for churn prediction and in-time retention planning and execution, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure describes a Software as a Service (SaaS) solution comprising an architecture of AI agents, algorithms, and processes operating in three phases to address customer churn. The system may operate on cloud hardware and/or on the premises hardware of an enterprise.

In Phase 1, the system determines which customers are likely to churn. This phase may include an automated machine learning pipeline that performs data preprocessing, data quality testing, model training, and deployment of endpoints with local and global explanations of churn predictions.

In Phase 2, the system predicts when identified customers will churn. This phase may apply survival analysis techniques to predict customer churn timelines, borrowing methodologies from the medical field.

In Phase 3, the system develops and implements strategies to retain at-risk customers. This phase may use a differential diagnosis approach to identify churn causes and appropriate treatments, implement personalized communication and incentives, and incorporate human verification and approval.

All tasks performed across these three phases may be orchestrated by specialized AI agents. These AI agents may be powered by specialized Large Language Models (LLMs) and/or Small Language Models (SLMs) responsible for planning their next steps based on data received from other AI agents or from clients or customers.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

The system may be implemented as an end-to-end Agentic AI solution to the customer retention problem. The system architecture may include multiple AI agents specialized for different functions within the customer retention process.

An orchestration layer may be implemented as a discrete software component executing on one or more computing devices 500, separate from the agent processes it coordinates. The orchestration layer may comprise an agent registry module, a message routing module, a performance monitoring module, and a priority queue manager. The message routing module may receive outgoing messages from agent processes, pass them to the schema validation module for validation against the registered schema, and upon successful validation, enqueue them in the priority queue manager for dispatch to the receiving agent. The performance monitoring module may track execution time, error rate, and output conformance for each agent execution and may log these metrics to the centralized database for use in dynamic parameter adjustment. The orchestration layer may expose a management interface through which human operators may inspect pipeline state, override agent parameters, and receive escalated failure alerts. In cloud deployments, the orchestration layer may be implemented as a managed workflow service.

### Phase 1: Churn Prediction

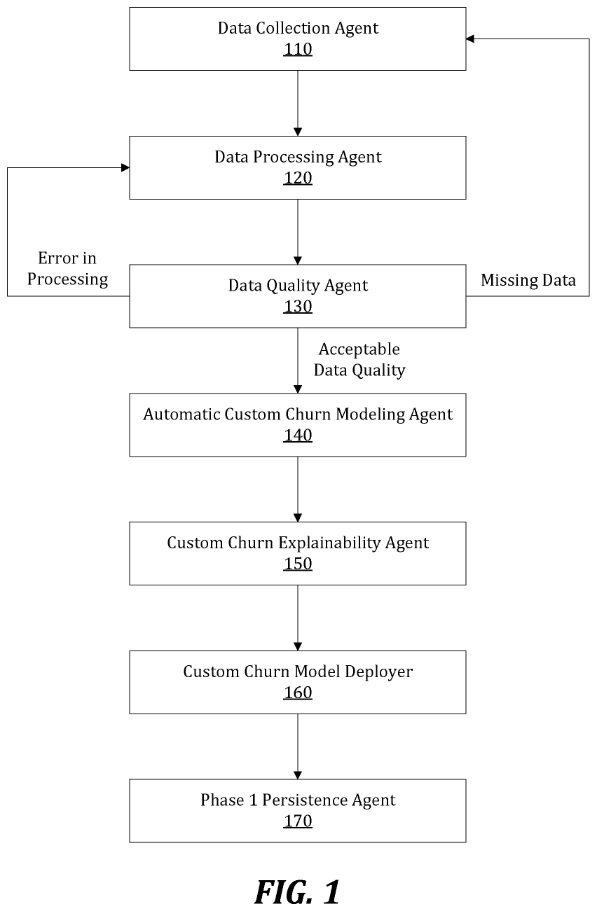

Referring to FIG. 1, a data flow diagram illustrates an AI agent ensemble for Phase 1 of the customer retention system. Phase 1 focuses on predicting which customers are likely to churn.

Phase 1 may be implemented as a subsystem comprising a plurality of interconnected AI agent components: a Data Collection Agent 110, a Data Processing Agent 120, a Data Quality Agent 130, an Automatic Custom Churn Modeling Agent 140, a Custom Churn Explainability Agent 150, a Custom Churn Model Deployer 160, and a Phase 1 Persistence Agent 170. Each component may execute as an independent software process or containerized microservice on one or more computing devices 500, with inter-component communication managed by the orchestration layer via the schema-validated inter-agent communication protocol.

The process begins with a Data Collection Agent 110, which is responsible for gathering customer data from various sources. This agent may interface with client databases, CRM systems, or other data repositories to collect relevant customer information.

The Data Collection Agent 110 may serve as the entry point of the Phase 1 subsystem. The Data Collection Agent 110 may be connected to one or more external data sources, including CRM systems, transaction databases, and customer interaction log repositories, via configurable source-specific connectors. The Data Collection Agent 110 may output a normalized customer dataset conforming to a common internal schema, which may be transmitted to the Data Processing Agent 120 as a structured message payload.

The collected data may then be passed to a Data Processing Agent 120, which performs necessary transformations, normalizations, and feature engineering on the raw data. This agent may select from a predefined set of data processing techniques based on the nature and quality of the input data.

The Data Processing Agent 120 may receive the normalized dataset from the Data Collection Agent 110 and may apply transformation, normalization, and feature engineering operations to produce a processed feature matrix. The Data Processing Agent 120 may be bidirectionally connected to the Data Quality Agent 130 via a feedback loop: the Data Processing Agent 120 may forward the processed feature matrix to the Data Quality Agent 130 for quality evaluation, and may receive remediation instructions from the Data Quality Agent 130 when quality tests fail.

The Data Quality Agent 130 may receive the processed feature matrix from the Data Processing Agent 120 and may apply automated quality tests comprising variance inflation factor computation for multicollinearity detection, point-biserial correlation analysis for target leakage detection, and Pearson correlation analysis for feature redundancy detection. Upon passing all quality tests, the Data Quality Agent 130 may forward the validated feature matrix to the Automatic Custom Churn Modeling Agent 140 via the orchestration layer.

If missing data is detected, the process may flow to a Data Quality Agent 130, which runs various tests such as multicollinearity detection, target leakage identification, and feature correlation analysis. If the Data Quality Agent 130 detects errors in processing, it may loop back to the Data Processing Agent 120 for additional processing. The Data Quality Agent 130 may continue testing until acceptable data quality is achieved.

Once the data meets quality standards, it may be forwarded to an Automatic Custom Churn Modeling Agent 140. This agent may perform model selection depending on the data size and features and choose training algorithms that are considered to be Explainable AI algorithms. The Automatic Custom Churn Modeling Agent 140 may train the selected model with automatic hyperparameter tuning and generate model performance reports.

The Automatic Custom Churn Modeling Agent 140 may receive the validated feature matrix and may perform algorithm selection, model training, and hyperparameter optimization. The Automatic Custom Churn Modeling Agent 140 may output a trained model artifact and a model performance report, both of which may be transmitted to the Custom Churn Explainability Agent 150 and to the Phase 1 Persistence Agent 170.

The trained model and associated data may then be passed to a Custom Churn Explainability Agent 150, which produces local and global explanation reports. These reports may identify features contributing to churn predictions for individual customers (local explanations) and broader patterns across customer segments (global explanations).

The Custom Churn Explainability Agent 150 may receive the trained model artifact and the validated feature matrix from the Automatic Custom Churn Modeling Agent 140 and may generate local and global explanation reports from a variety of explainable AI techniques such as (but not limited to) SHAP value computation. The Custom Churn Explainability Agent 150 may transmit the explanation reports to the Phase 1 Persistence Agent 170 and may also forward them to the Custom Churn Model Deployer 160 for inclusion in the deployed model service.

A Custom Churn Model Deployer 160 may then deploy the trained and evaluated model as a service for the client. This deployed model may be used to make predictions about which customers are at risk of churning.

The Custom Churn Model Deployer 160 may receive the trained model artifact and explanation reports and may package them into a deployable inference service exposing API endpoints for churn prediction requests. The Custom Churn Model Deployer 160 may be connected to the Phase 1 Persistence Agent 170, which may store the deployed model endpoint reference alongside all reports and model artifacts generated during Phase 1.

The inference service deployed by the Custom Churn Model Deployer 160 may expose one or more REST API endpoints accessible to downstream agents within the pipeline. A prediction endpoint may accept as input a JSON payload comprising a customer identifier produced during Phase 1 data processing. The prediction endpoint may return a JSON response comprising the customer identifier, a churn probability score between zero and one, a binary churn prediction label, and a local explanation details. A batch prediction endpoint may additionally accept an array of customer feature vectors and may return an array of corresponding prediction responses, enabling the pipeline to generate churn predictions for all at-risk customers in a single API call. The inference service is deployed as an on-demand serverless as a cost-effective measure. The deployed endpoint reference, comprising the service URL and authentication credentials, may be stored by the Phase 1 Persistence Agent 170 in the centralized database and retrieved by downstream agents when invoking the inference service for churn prediction requests.

Finally, a Phase 1 Persistence Agent 170 may store all reports and information generated during this phase in a database for use by downstream AI agents in subsequent phases.

The Phase 1 Persistence Agent 170 may serve as the terminal component of the Phase 1 subsystem and may maintain a read/write interface to the churn prediction data store within the centralized database. The Phase 1 Persistence Agent 170 may make all Phase 1 outputs, including model artifacts, prediction scores, and explainability reports, available to the downstream agents in Phase 2 and Phase 3 via the centralized database.

The Phase 1 Persistence Agent 170, the Phase 2 Persistence Agent 260, and the Phase 3 Persistence Agent 360 may each be implemented as discrete software processes within the persistence subsystem, each scoped to a distinct data store partition within the centralized database. The Phase 1 Persistence Agent 170 may maintain a read/write interface to the churn prediction data store, which may comprise tables or collections for model artifacts, prediction scores, hyperparameter configurations, cross-validation results, and explanation reports. The Phase 2 Persistence Agent 260 may maintain a read/write interface to the churn timeline data store, which may comprise tables or collections for Kaplan-Meier survival curves, predicted median survival times, churn window estimates, urgency tier assignments, and composite urgency scores. The Phase 3 Persistence Agent 360 may maintain a read/write interface to the retention outcomes data store, which may comprise tables or collections for differential diagnosis results, treatment recommendations, generated communications, operator decisions, delivery records, customer response observations, and Bayesian Network conditional probability tables. The “update system knowledge” function of the Phase 3 Persistence Agent 360 may be implemented by writing updated Bayesian Network conditional probability tables to the retention outcomes data store following each CPT update cycle performed by the Relief Retention Analytics Agent 350, making the updated tables available to the Customer Differential Diagnosis Agent 310 at the start of the next diagnostic cycle via a read operation on the same data store.

### Phase 2 and 3: Churn Timeline and Retention Planning

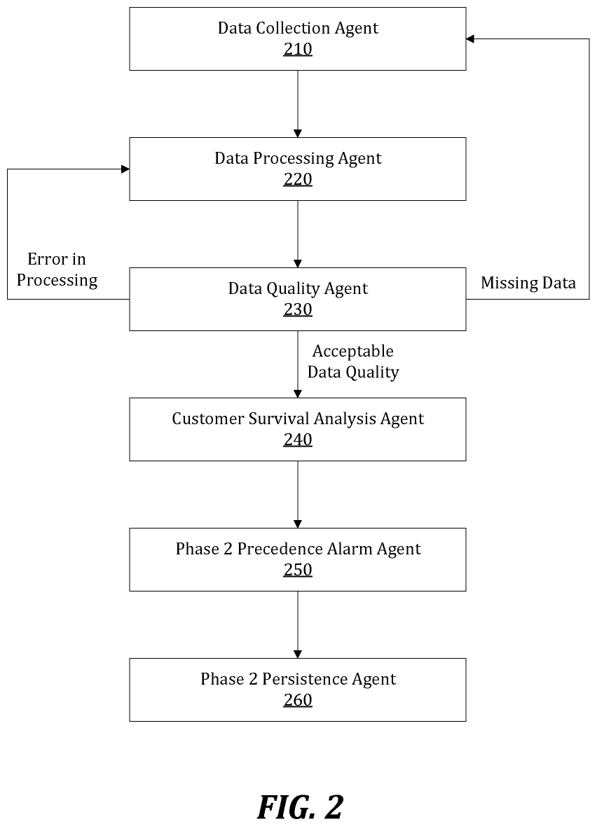

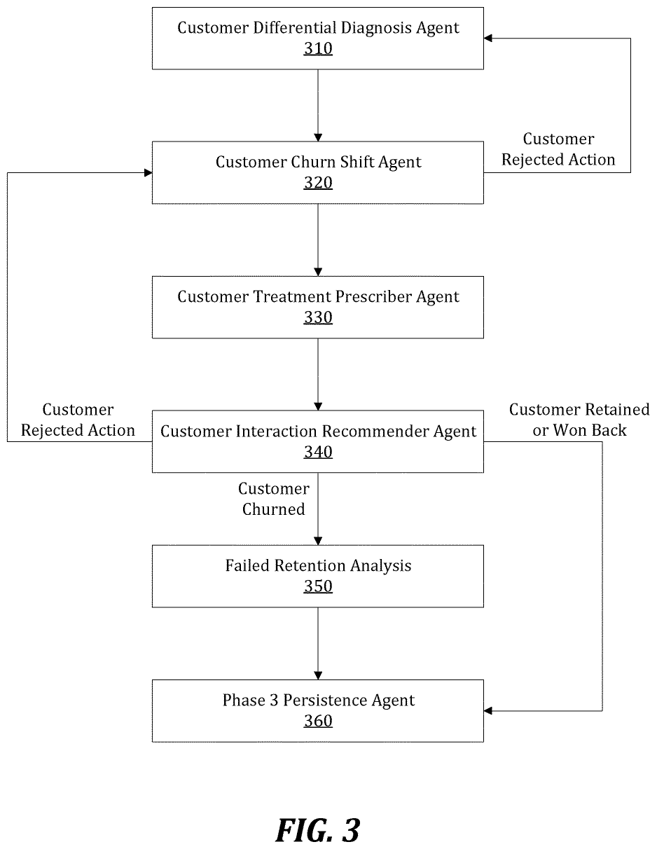

Referring to FIGS. 2 and 3, data flow diagrams illustrate AI agents for Phase 2 and Phase 3 of the customer retention system. These phases focus on predicting when customers will churn and developing strategies to retain them.

Phase 2 may be implemented as a subsystem comprising six interconnected AI agent components: a Data Collection Agent 210, a Data Processing Agent 220, a Data Quality Agent 230, a Customer Survival Analysis Agent 240, a Phase 2 Precedence Alarm Agent 250, and a Phase 2 Persistence Agent 260. Each component may execute as an independent software process or containerized microservice on one or more computing devices 500, with inter-component communication managed by the orchestration. Phase 2 may receive its primary inputs from the Phase 1 Persistence Agent 170 via the centralized database, consuming the churn probability scores, trained model artifacts, and explainability reports generated during Phase 1.

Similar to Phase 1, Phase 2 begins with a Data Collection Agent 210, a Data Processing Agent 220, and a Data Quality Agent 230. These agents may be responsible for collecting, processing, and testing the quality of customer data, respectively. In Phase 2, these agents may utilize both client-provided data and data produced during Phase 1.

The Data Collection Agent 210 may serve as the entry point of the Phase 2 subsystem. The Data Collection Agent 210 may connect to the same external data sources as the Data Collection Agent 110 in Phase 1 via the same configurable source-specific connectors, and may additionally retrieve the churn probability scores and customer risk profiles stored by the Phase 1 Persistence Agent 170 in the centralized database. The Data Collection Agent 210 may output a normalized dataset combining fresh customer data with Phase 1 outputs, transmitted to the Data Processing Agent 220 as a structured message payload.

The Data Processing Agent 220 may receive the combined dataset from the Data Collection Agent 210 and may apply transformation, normalization, and feature engineering operations to produce a processed feature matrix suitable for survival analysis. The Data Processing Agent 220 may be bidirectionally connected to the Data Quality Agent 230 via a feedback loop: the Data Processing Agent 220 may forward the processed feature matrix to the Data Quality Agent 230 for quality evaluation, and may receive remediation instructions from the Data Quality Agent 230 when quality tests fail.

The Data Quality Agent 230 may receive the processed feature matrix from the Data Processing Agent 220 and may apply the same automated quality tests used in Phase 1, comprising variance inflation factor computation, point-biserial correlation analysis, and Pearson correlation analysis. Upon passing all quality tests, the Data Quality Agent 230 may forward the validated feature matrix to the Customer Survival Analysis Agent 240 via the orchestration layer.

A Customer-Operated Automated Elliptical Training Process may then train models specific to the customer's data and business context. This may be followed by a Customer Data Quality module of the Data Processing Agent 220, which ensures the quality of customer-specific data.

The process may continue with a Customer-Supplied Automated Content Adaptation module 240, which may adapt content based on customer-specific requirements and preferences.

The Customer Survival Analysis Agent 240 may serve as the primary modeling component of the Phase 2 subsystem. The Customer Survival Analysis Agent 240 may receive the validated feature matrix and the churn probability scores from Phase 1 and may fit a Kaplan-Meier estimator to the population of at-risk customers to produce a population-level survival function. The agent may then generate a customer-specific survival estimate for each at-risk customer by adjusting the population-level baseline using the customer's individual feature values and churn probability score. The Customer Survival Analysis Agent 240 may output, for each at-risk customer, a predicted median survival time, a predicted churn window, and a composite urgency score combining the churn probability and the inverse of the predicted time-to-churn. These outputs may be transmitted as a structured message payload to both the Phase 2 Precedence Alarm Agent 250 and the Phase 2 Persistence Agent 260.

The Phase 2 Precedence Alarm Agent 250 may receive the survival analysis outputs from the Customer Survival Analysis Agent 240 and may monitor each customer's predicted time-to-churn against a configurable urgency threshold. When a customer's predicted time-to-churn falls below the threshold, the Phase 2 Precedence Alarm Agent 250 may generate and dispatch an alert comprising the customer identifier, predicted churn probability score, estimated time-to-churn, identified churn cause categories, and recommended retention action. The Phase 2 Precedence Alarm Agent 250 may be connected to one or more notification delivery channels, including email, SMS, and in-application dashboard interfaces, and may route each alert to the appropriate channel based on operator-configured preferences.

The Phase 2 Persistence Agent 260 may serve as the terminal component of the Phase 2 subsystem and may maintain a read/write interface to the churn timeline data store within the centralized database. The Phase 2 Persistence Agent 260 may store all Phase 2 outputs, including survival analysis results, urgency tier assignments, composite urgency scores, and survival curve plots, in the centralized database. These outputs may be made available to the downstream agents in Phase 3 via the centralized database, enabling the Customer Differential Diagnosis Agent 310 to prioritize at-risk customers by urgency when initiating the differential diagnosis process.

A Customer System Shift module may adapt the system to changes in customer behavior or business conditions. This may be followed by a Customer-Operated Precise Adaptation module, which fine-tunes the system based on customer feedback and validation.

Another Customer System Shift module may further adapt the system based on new insights or changing conditions. A Fulfilled Provision module may then implement the recommended retention strategies.

The process may conclude with a Phase 2 Precedence Alarm Agent 360, which monitors the system and alerts relevant stakeholders when necessary.

Phase 3 may be implemented as a subsystem comprising seven interconnected AI agent components: a Customer Differential Diagnosis Agent 310, a Customer Churn Shift Agent 320, a Customer Treatment Prescriber Agent 330, a Customer Interaction Recommender Agent 340, a Relief Retention Analytics Agent 350, a Persistence Agent 360, and a human verification interface. Each component may execute as an independent software process or containerized microservice on one or more computing devices 500, with inter-component communication managed by the orchestration layer via the schema-validated inter-agent communication protocol. Phase 3 may receive its primary inputs from the Phase 2 Persistence Agent 260 via the centralized database, consuming the composite urgency scores, urgency tier assignments, survival analysis outputs, and churn probability scores generated during Phases 1 and 2.

The Customer Differential Diagnosis Agent 310 may serve as the entry point of the Phase 3 subsystem. The Customer Differential Diagnosis Agent 310 may retrieve the ranked list of at-risk customers from the centralized database, ordered by composite urgency score, and may initiate a differential diagnosis for each customer by performing probabilistic inference over a Bayesian Network comprising churn cause nodes and retention treatment nodes. The Customer Differential Diagnosis Agent 310 may output, for each customer, a posterior probability distribution over churn cause categories, which may be transmitted as a structured message payload to the Customer Churn Shift Agent 320 and the Customer Treatment Prescriber Agent 330.

The Customer Churn Shift Agent 320 may receive the initial differential diagnosis from the Customer Differential Diagnosis Agent 310 and may monitor incoming data streams for new customer information that may alter the diagnosis. Upon detecting new information, the Customer Churn Shift Agent 320 may update the evidence variables for the affected customer and may submit a re-diagnosis request to the Customer Differential Diagnosis Agent 310 via the orchestration layer. The Customer Churn Shift Agent 320 may be bidirectionally connected to the Customer Differential Diagnosis Agent 310 via this re-diagnosis feedback loop, enabling iterative refinement of the diagnosis as new evidence becomes available.

The Customer Treatment Prescriber Agent 330 may receive the posterior probability distribution over churn cause nodes from the Customer Differential Diagnosis Agent 310 and may traverse the directed edges of the Bayesian Network from the highest-probability cause nodes to identify the treatment nodes with the highest conditional probability of success. The Customer Treatment Prescriber Agent 330 may output a ranked list of recommended treatments for each at-risk customer, transmitted as a structured message payload to the Customer Interaction Recommender Agent 340.

The Customer Interaction Recommender Agent 340 may receive the ranked treatment recommendations from the Customer Treatment Prescriber Agent 330 and may construct a structured prompt comprising the customer's churn probability score, predicted churn timeline, identified churn cause category, ranked treatments, and historical engagement patterns. The Customer Interaction Recommender Agent 340 may submit this prompt to a specialized Large Language Model to generate a personalized retention communication formatted for the customer's preferred channel. The generated communication may be transmitted as a structured message payload to the human verification interface.

The human verification interface may receive the generated retention recommendations from the Customer Interaction Recommender Agent 340 and may present each recommendation to a human operator through a dashboard or review queue. The human operator may approve, modify, or reject each recommendation individually. Approved and modified recommendations may be routed by the human verification interface to the designated delivery channel for transmission to the customer. Rejected recommendations may be logged with an optional reason code and flagged for re-evaluation. The human verification interface may be connected to the Persistence Agent 360, which may store the operator's decision and the final communication for each customer.

The Relief Retention Analytics Agent 350 may monitor retention outcomes over a configurable observation window following each implemented retention action. The Relief Retention Analytics Agent 350 may retrieve outcome records from the Persistence Agent 360, compute updated conditional probability tables for the Bayesian Network using a Bayesian update rule, and return the updated tables to the Persistence Agent 360 for storage. The Relief Retention Analytics Agent 350 may also aggregate outcome records to identify patterns in successful and unsuccessful retention attempts across customer segments, generating summary reports for use by the orchestration layer in adjusting agent parameters.

The Persistence Agent 360 may serve as the terminal component of the Phase 3 subsystem and may maintain a read/write interface to the retention outcomes store within the centralized database. The Persistence Agent 360 may store all Phase 3 outputs, including differential diagnosis results, treatment recommendations, generated communications, operator decisions, delivery records, retention outcomes, and updated Bayesian Network conditional probability tables. Updated conditional probability tables may be loaded by the Customer Differential Diagnosis Agent 310 at the start of each new diagnostic cycle, closing the feedback loop and enabling the Phase 3 subsystem to improve the precision of its retention recommendations over successive pipeline executions.

### AI Agent Interconnections

A Customer Survival Analysis Agent 240 may generate code for estimators that predict when a customer is likely to cancel their services or subscription. This agent may fit a survival function for each customer to estimate how long they remain subscribed before churning. The Kaplan-Meier estimator, also known as the product limit estimator, may be used to estimate the survival function from lifetime data.

A Customer Differential Diagnosis Agent 310 may perform differential diagnosis on customers identified as likely to churn, prioritizing those predicted to churn sooner and with higher revenue impact. This agent may produce code and modeling based on Bayesian Networks that represent probabilistic relationships between churn causes (symptoms) and preventive actions (treatments). Symptoms may include features contributing to churn predictions (determined in Phase 1) as well as information from domain experts and business owners, and other available data sources such customer surveys and Voice of Customer (VoC) data if available from the Data Collection Agent 210.

A Customer Churn Shift Agent 320 and a Customer Treatment Prescriber Agent 330 may orchestrate communication with the Customer Differential Diagnosis Agent 310 to update the differential diagnosis and rule in or rule out causes of churn and potential remedies.

A Customer Interaction Recommender Agent 340 may negotiate and test incentives and treatments with customers (via humans-in-the-loop). This agent may generate communications and personalized messages using a specialized LLM that leverages offer/mitigation plans in a cooperative setting between the company and customers.

If offers, incentives, and treatments fail and a customer churns, a Relief Retention Analytics Agent 350 may review incentives and treatments for similar customers and/or alert business owners and humans-in-the-loop by persisting this information in respective databases through a Persistence Agent 360.

### III. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Method Overview

The method may improve customer retention through an agentic artificial intelligence pipeline that reduces manual data science overhead. The method may further increase churn prediction accuracy through automated algorithm selection and cross-validated model evaluation, and generate personalized retention communications without human authoring.

The method may be performed by a plurality of specialized AI agents coordinated by an orchestration layer that activates, sequences, and monitors each agent via a schema-validated inter-agent communication protocol. The orchestration layer may dispatch structured messages conforming to a defined schema comprising a task type identifier, a priority level, an input data payload, and a required output format specification, and may enter a waiting state after each dispatch until the receiving agent returns a schema-conformant response message. This synchronous dispatch-and-wait cycle may produce deterministic agent sequencing without requiring centralized synchronization locks, reducing inter-process communication errors and improving pipeline throughput relative to conventional multi-agent architectures. In a first phase, a Data Collection Agent 110 may gather customer data from multiple heterogeneous sources including CRM systems, transaction databases, and customer interaction logs via configurable source-specific connectors, normalizing the collected data into a common internal schema for downstream processing. A Data Processing Agent 120 may apply transformation, normalization, and other standard data processing techniques, which may normalize and/or standardize data for forwarding to a Data Quality Agent 130 for automated quality testing comprising various standard and custom statistical data quality tests. Upon passing all quality tests, an Automatic Custom Churn Modeling Agent 140 generates a custom model training plan based on the input from the Data Quality Agent 130 and business domain. The Automatic Custom Churn Modeling Agent 140 may also create custom modeling and training plans. Automatic Custom Churn Modeling Agent 140 may iterate over a variety of machine learning techniques and choose one or more candidate machine learning algorithms using a variety of techniques identified in the generated model training plan, including but not limited to k-fold cross-validation, and automatic hyperparameter tuning to choose the best model. A Custom Churn Explainability Agent 150 may then generate local and global explanation reports, and a Phase 1 Persistence Agent 170 may store all model artifacts, prediction scores, and explanation reports in a centralized database for access by downstream agents.

In a second phase, a Customer Survival Analysis Agent 240 may retrieve the churn probability scores from the centralized database and may fit a Kaplan-Meier estimator to the population of at-risk customers to produce a population-level survival function. The agent may generate a customer-specific survival estimate for each at-risk customer by adjusting the population-level baseline using the customer's individual feature values and churn probability score, producing a predicted median survival time, a predicted churn window, and a composite urgency score computed as a weighted combination of the churn probability and the inverse of the predicted time-to-churn. A Phase 2 Precedence Alarm Agent 250 may issue alerts for customers whose predicted time-to-churn falls below a configurable urgency threshold, and a Phase 2 Persistence Agent 260 may store all survival analysis outputs in the centralized database for use in the third phase.

In the third phase, a Customer Differential Diagnosis Agent 310 may retrieve the ranked list of at-risk customers ordered by composite urgency score and may perform probabilistic inference over a Bayesian Network comprising churn cause nodes and retention treatment nodes to identify the most probable causes of churn for each customer. A Customer Churn Shift Agent 320 may monitor incoming data streams for new customer information and may submit re-diagnosis requests to update the differential diagnosis as new evidence becomes available. A Customer Treatment Prescriber Agent 330 may traverse the Bayesian Network from the highest-probability cause nodes to identify the treatment nodes with the highest conditional probability of success. A Customer Interaction Recommender Agent 340 may construct a structured prompt conditioned on the identified churn cause, mapped treatment, and historical engagement patterns, and may submit the prompt to a Large Language Model to generate a personalized retention communication formatted for the customer's preferred channel. The generated communication may be presented to a human operator through a verification interface, where the operator may approve, modify, or reject each recommendation individually before any retention action is transmitted to the customer. A Relief Retention Analytics Agent 350 may subsequently monitor customer responses over a configurable observation window and may update the Bayesian Network conditional probability tables using a Bayesian update rule scaled by a configurable learning rate, enabling the pipeline to improve the precision of its retention recommendations over successive executions.

### Phase 1: who Will Churn?

In Phase 1, the system may predict which customers are likely to churn. This phase may involve several steps orchestrated by specialized AI agents.

The Data Collection Agent 110 may gather relevant customer data from various sources. This may include demographic information, purchase history, product usage patterns, customer service interactions, billing information, and other relevant data points. The agent may interface with client databases, CRM systems, and other data repositories to collect this information.

The Data Collection Agent 110 may interface with multiple heterogeneous data sources through a set of configurable connectors, each tailored to a specific source type. For CRM systems, the agent may connect via REST API or native SDK integrations, authenticating using OAuth 2.0 tokens or API keys stored in a secure credential store. For transaction databases, the agent may connect via JDBC or ODBC drivers, executing parameterized queries to extract customer transaction records within a configurable lookback window. Upon collection, data from each source may be normalized into a common internal schema comprising at least a customer identifier, a timestamp, a data category, and a value field, enabling downstream agents to process data from all sources in a uniform format regardless of the originating system. The agent may log the source, record count, and collection timestamp for each data pull to support auditability and data lineage tracking.

The Data Processing Agent 120 may perform necessary transformations on the collected data to prepare it for analysis. This may include handling missing values, normalizing numerical features, encoding categorical variables, and creating derived features that may be predictive of churn. The agent may select appropriate processing techniques based on the nature and quality of the input data.

The Data Quality Agent 130 may run various tests to ensure the processed data meets quality standards for model training. These tests may include checks for multicollinearity, target leakage, and feature correlation. If issues are detected, the agent may flag them and potentially loop back to the Data Processing Agent 120 for additional processing. The agent may continue testing until the data meets acceptable quality standards.

The Data Quality Agent 130 may apply a defined set of automated quality tests to the processed dataset before forwarding it to the Automatic Custom Churn Modeling Agent 140. Multicollinearity detection may be performed by computing the variance inflation factor (VIF) for each feature, with features exceeding a configurable VIF threshold flagged for removal or consolidation. Target leakage detection may be performed by computing the point-biserial correlation between each feature and the churn label, with features exhibiting a correlation above a configurable threshold flagged as potential leakage candidates and excluded from model training. Feature correlation analysis may identify pairs of features with a Pearson correlation coefficient exceeding a configurable threshold, with one feature from each highly correlated pair removed to reduce redundancy. If any test produces a failure, the Data Quality Agent 130 may generate a quality report specifying the failing features and the nature of each failure, and may return the dataset to the Data Processing Agent 120 with instructions for remediation. The Data Processing Agent 120 may apply the specified remediations and resubmit the dataset to the Data Quality Agent 130 for re-evaluation. This loop may continue until all quality tests pass or until a configurable maximum number of iterations is reached, at which point the system may escalate to a human operator.

The Automatic Custom Churn Modeling Agent 140 generates a custom and model training plan based on the input from the Data Quality Agent 130 and business domain, as well as creating custom modeling and training plans. Automatic Custom Churn Modeling Agent 140 may iterate over a variety of machine learning techniques and choose one or more candidate machine learning algorithms using a variety techniques identified in the generated model training plan, including but not limited to k-fold cross-validation, and automatic hyperparameter tuning to choose the best model may select an appropriate machine learning algorithm from a predefined set based on the characteristics of the prepared data. The agent may consider factors such as data size, feature types, and the presence of class imbalance when selecting an algorithm. The agent may train the selected model with automatic hyperparameter tuning to optimize performance and generate comprehensive performance reports.

The Custom Churn Explainability Agent 150 may analyze the trained model to produce both local and global explanations. Local explanations may identify the specific features and their values that contribute to churn predictions for individual customers. Global explanations may reveal broader patterns and feature importance across the entire customer base or within specific segments. These explanations may be essential for understanding the factors driving churn and for informing retention strategies in later phases.

To generate local explanations, the Custom Churn Explainability Agent 150 may apply SHapley Additive exPlanations (SHAP) to compute a SHAP value for each feature for each individual customer prediction. The SHAP value for a feature may represent the marginal contribution of that feature to the difference between the customer's predicted churn probability and the baseline prediction across the training dataset. Local explanation reports may comprise, for each at-risk customer, a ranked list of features ordered by absolute SHAP value, the direction of each feature's contribution (positive or negative), and the customer's actual feature value alongside the population median for reference. To generate global explanations, the agent may aggregate SHAP values across all customers in the prediction batch to compute mean absolute SHAP values for each feature, producing a global feature importance ranking. Global explanation reports may comprise a ranked list of features by mean absolute SHAP value, a summary of the distribution of SHAP values for each top-ranked feature across customer segments, and a set of partial dependence plots illustrating the relationship between each top feature and predicted churn probability. Both local and global explanation reports may be stored by the Phase 1 Persistence Agent 170 and made available to downstream agents in Phase 3 as inputs to the differential diagnosis process.

The Custom Churn Model Deployer 160 may package the trained and evaluated model into a deployable service for the client. This may include creating API endpoints that allow the client to submit customer data and receive churn predictions and explanations.

The Phase 1 Persistence Agent 170 may store all reports, model artifacts, and other information generated during this phase in a database. This information may be accessed by downstream AI agents in subsequent phases to inform their operations.

### Phase 2: When Will They Churn?

In Phase 2, the system may predict when identified at-risk customers are likely to churn. This phase may apply survival analysis techniques borrowed from the medical field.

In some embodiments, the churn probability prediction performed in Phase 1 and the churn timeline prediction performed in Phase 2 may be combined into a unified churn forecasting operation executed by a set of custom modeling agents. The custom modeling agents may first generate a churn probability score for each customer using the trained classification model from Phase 1, and may then apply survival analysis techniques from Phase 2 to estimate the predicted time-to-churn for each customer identified as at risk. The outputs of these two operations may be combined into a unified customer risk profile comprising the churn probability score, the predicted churn timeline, and the composite urgency score, which may be passed as a single structured payload to the downstream retention planning agents in Phase 3. This unified forecasting operation may allow the system to characterize both the likelihood and the timing of churn for each at-risk customer in a single pipeline execution, enabling more precise prioritization of retention interventions.

The Customer Survival Analysis Agent may generate code for estimators that predict when a customer is likely to cancel their services or subscription. The agent may fit a survival function for each customer that estimates how long they remain subscribed before churning.

The Kaplan-Meier estimator, also known as the product limit estimator, may be one algorithm used to estimate the survival function from lifetime data. This non-parametric statistic may be used to estimate the survival probability as a function of time.

To fit a Kaplan-Meier estimator for each customer, the Customer Survival Analysis Agent 240 may define the event variable as the occurrence of customer churn, represented as a binary indicator, and the time variable as the duration of the customer's relationship with the business measured in days or months from the customer's start date to either the churn event or the observation cutoff date. Customers who have not churned by the observation cutoff date may be treated as right-censored observations, meaning their survival time is known to exceed the observed duration but the exact churn date is unknown. The Kaplan-Meier estimator may be fitted to the population of at-risk customers identified in Phase 1, producing a step-function estimate of the survival probability S(t) at each observed event time t. For each individual at-risk customer, the agent may apply the fitted population-level survival function as a baseline and may adjust the predicted survival curve using the customer's individual feature values and churn probability score from Phase 1 to produce a customer-specific survival estimate. The output for each customer may comprise a predicted median survival time representing the time at which the customer's survival probability falls below 0.5, a predicted churn window defined by the interquartile range of the survival distribution, and a survival curve plot stored in the centralized database for review by human operators.

Other survival analysis techniques that may be employed include the Cox Proportional Hazards model, which may allow for the examination of the relationship between survival time and predictor variables, or parametric models such as the Weibull or exponential distributions.

The output of this phase may be a timeline prediction for each customer identified as at risk of churning in Phase 1. This timeline may indicate the expected time window during which the customer is likely to churn, allowing for prioritization of retention efforts based on urgency.

To generate a ranked intervention queue, the system may combine the churn probability score produced in Phase 1 with the predicted churn timeline produced in Phase 2 into a composite urgency score for each at-risk customer. The composite urgency score may be computed as a weighted combination of the churn probability and the inverse of the predicted time-to-churn, such that customers with both a high churn probability and a short predicted time-to-churn receive the highest urgency scores. The weights applied to each component may be configurable by the business operator and may default to equal weighting. Based on the composite urgency score, each at-risk customer may be assigned to one of a plurality of urgency tiers, such as a high-urgency tier for customers predicted to churn within a short defined window, a medium-urgency tier for customers predicted to churn within a medium defined window, and a low-urgency tier for customers predicted to churn beyond a longer defined window. The urgency tier may determine the priority level and communication channel assigned to the retention action directed to that customer, with high-urgency customers receiving immediate outreach through direct channels such as phone or personalized email, and lower-urgency customers receiving scheduled outreach through lower-cost channels.

### Phase 3: How to Retain Customers?

In Phase 3, the system may develop and implement strategies to retain at-risk customers. This phase may borrow concepts from medical differential diagnosis to identify churn causes and appropriate treatments.

The Customer Differential Diagnosis Agent 310 may perform differential diagnosis on customers identified as likely to churn, prioritizing those predicted to churn sooner and with higher revenue impact. This agent may construct Bayesian Networks that represent probabilistic relationships between churn causes (symptoms) and preventive actions (treatments).

The Bayesian Network constructed by the Customer Differential Diagnosis Agent 310 may comprise a directed acyclic graph (DAG) in which nodes represent churn cause categories and retention treatment categories, and directed edges represent conditional probabilistic dependencies between them. Churn cause nodes may include, but are not limited to, product dissatisfaction, pricing sensitivity, competitive offers, service quality issues, and life event triggers. Each cause node may be associated with a set of observable evidence variables drawn from customer data, such as declining feature usage frequency as evidence for product dissatisfaction, or increased support ticket volume as evidence for service quality issues. Retention treatment nodes may include, but are not limited to, personalized discount offers, product education campaigns, service upgrade proposals, contract renegotiation, and proactive customer success outreach. Directed edges from cause nodes to treatment nodes may encode the conditional probability that a given treatment is effective given a particular cause, based on historical retention outcome data. The Customer Differential Diagnosis Agent 310 may perform probabilistic inference over the Bayesian Network using observed customer evidence to compute a posterior probability distribution over cause nodes, identifying the most probable causes of churn for each individual customer. The Customer Treatment Prescriber Agent 330 may then traverse the edges from the highest-probability cause nodes to identify the treatment nodes with the highest conditional probability of success, and may output a ranked list of recommended treatments for each at-risk customer.

Symptoms may include features identified as contributing to churn predictions in Phase 1, such as declining usage patterns, increased support tickets, or payment issues. Symptoms may also be drawn from domain experts and business owners, including customer surveys and Voice of Customer (VoC) data if available.

Treatments may include various retention strategies such as personalized offers, product education, service improvements, or pricing adjustments. These treatments may be mapped to specific symptoms or combinations of symptoms through the Bayesian Network.

The Customer Churn Shift Agent 320 and Customer Treatment Prescriber Agent 330 may orchestrate communication with the Customer Differential Diagnosis Agent 310. They may update the differential diagnosis based on new information and rule in or rule out causes of churn and potential remedies.

The Customer Churn Shift Agent 320 may monitor incoming data streams for new information that may alter the differential diagnosis for one or more at-risk customers. New information may include, but is not limited to, updated customer interaction records, new support ticket submissions, changes in product usage frequency, updated Net Promoter Score responses, or new Voice of Customer data received after the initial diagnostic cycle. Upon detecting new information for a customer, the Customer Churn Shift Agent 320 may update the evidence variables associated with that customer's Bayesian Network inference and may submit a re-diagnosis request to the Customer Differential Diagnosis Agent 310. The Customer Differential Diagnosis Agent 310 may then recompute the posterior probability distribution over churn cause nodes using the updated evidence, producing a revised ranked list of probable churn causes. If the revised diagnosis results in a change to the highest-probability cause category, the Customer Churn Shift Agent 320 may notify the Customer Treatment Prescriber Agent 330 to generate an updated treatment recommendation based on the new diagnosis. A cause may be considered “ruled in” when its posterior probability exceeds a configurable threshold, and “ruled out” when its posterior probability falls below a configurable minimum threshold, at which point it may be removed from the active cause list for that customer.

The Customer Interaction Recommender Agent 340 may generate communications and personalized messages to be sent to at-risk customers. This agent may use a specialized LLM that crafts messages leveraging offer/mitigation plans in a cooperative setting between the company and customers. These communications may be sent to humans-in-the-loop (e.g., account managers or sales team members) for verification and approval before being sent to customers.

To condition the Large Language Model on the identified churn cause and mapped treatment, the Customer Interaction Recommender Agent 340 may construct a structured prompt comprising the customer's churn probability score, predicted churn timeline, identified churn cause category, ranked treatment recommendations from the Customer Treatment Prescriber Agent 330, and a summary of the customer's historical engagement patterns. Historical engagement patterns may include metrics such as average response rate to prior communications, preferred contact times, previously accepted or rejected offers, and channel interaction history. The preferred communication channel for each customer may be determined by the agent by analyzing the channel through which the customer has historically exhibited the highest engagement rate, or by retrieving a channel preference explicitly recorded in the customer's profile. The LLM may then generate a personalized retention communication adapted in tone, format, and incentive type based on these inputs. For example, a customer diagnosed with pricing sensitivity may receive a communication in a direct, value-focused tone offering a discounted rate, delivered via the customer's preferred channel such as email or SMS. A customer diagnosed with product dissatisfaction may receive a communication offering a product education session or a feature upgrade, adapted in tone to be supportive and informative. The generated communication may be formatted for the target channel, with email communications including a subject line and structured body, and SMS communications condensed to a defined character limit.

If the implemented retention strategies fail and a customer churns, the Relief Retention Analytics Agent 350 may analyze what went wrong and update the system's knowledge. This agent may review the effectiveness of different incentives and treatments for similar customers and identify patterns in successful and unsuccessful retention attempts.

To analyze patterns in successful and unsuccessful retention attempts, the Relief Retention Analytics Agent 350 may aggregate retention outcome records from the Persistence Agent 360 across a configurable historical window and apply pattern detection techniques to identify systematic relationships between customer attributes, churn causes, applied treatments, and retention outcomes. Pattern detection may comprise computing success rates for each treatment-cause pair across customer segments defined by attributes such as tenure, product tier, and revenue contribution. The agent may identify treatments that consistently underperform across one or more customer segments and may flag these treatment-cause pairs for review. The agent may also identify customer attribute combinations that are associated with high retention success rates and may generate a summary report of these patterns for use by the orchestration layer in adjusting agent parameters. The output of this analysis may comprise a ranked list of treatment-cause pairs ordered by observed success rate within each customer segment, which may be used to update the conditional probability tables of the Bayesian Network and to inform the Customer Treatment Prescriber Agent 330 in subsequent diagnostic cycles.

To update the Bayesian Network based on observed retention outcomes, the Relief Retention Analytics Agent 350 may retrieve from the Persistence Agent 360 the records of implemented retention actions and their associated outcomes over a defined observation window following each intervention. For each customer record, the agent may identify the churn cause that was diagnosed, the treatment that was applied, and whether the customer was successfully retained within the observation window. The agent may use this outcome data to update the conditional probability tables (CPTs) of the Bayesian Network using a Bayesian update rule, incrementing the probability weight of treatment-cause pairs associated with successful retention outcomes and decrementing the weight of pairs associated with unsuccessful outcomes. The magnitude of each update may be scaled by a configurable learning rate to prevent overfitting to recent outcomes. Updated CPTs may be persisted to the database by the Persistence Agent 360 and loaded by the Customer Differential Diagnosis Agent 310 at the start of each new diagnostic cycle, ensuring that the Bayesian Network reflects the most recent observed treatment effectiveness data.

The operations for updating Bayesian Network conditional probability distributions and adjusting treatment mappings may be implemented as executable instructions stored on a non-transitory computer-readable storage medium and executed by the computing system. These instructions may cause the computing system to retrieve retention outcome records from the centralized database, compute updated conditional probability distributions for each churn cause node using a Bayesian update rule applied to observed treatment outcomes, and persist the updated conditional probability tables to the database for use in subsequent diagnostic cycles. The instructions may further cause the computing system to adjust the directed edge weights between churn cause nodes and retention treatment nodes in the Bayesian Network, increasing the weight of edges connecting cause-treatment pairs associated with successful retention outcomes and decreasing the weight of edges associated with unsuccessful outcomes, scaled by a configurable learning rate. These stored instructions may be executed automatically at the conclusion of each observation window without requiring manual intervention, enabling the computing system to autonomously improve the precision of its retention recommendations over successive pipeline executions.

The Persistence Agent 360 may store information about retention attempts, customer responses, and outcomes in a database. This information may be used to improve future retention strategies and may be made available to business owners and humans-in-the-loop through alerts or reports.

The Phase 2 Precedence Alarm Agent may monitor the churn timeline predictions generated by the Customer Survival Analysis Agent 240 and may issue alerts when a customer's predicted time-to-churn falls below a configurable urgency threshold. An alert may comprise the customer identifier, the predicted churn probability score, the estimated time-to-churn, the identified churn cause categories, and the recommended retention action. Alerts may be delivered to designated stakeholders through one or more notification channels, such as email, SMS, or an in-application dashboard notification, based on operator-configured preferences. The Persistence Agent 360 may store all data generated across Phases 1, 2, and 3 in a centralized database accessible to all agents in the pipeline. The centralized database may be organized into distinct data stores for each phase, comprising at least a churn prediction store containing model artifacts, prediction scores, and explainability reports from Phase 1; a churn timeline store containing survival analysis outputs and urgency tier assignments from Phase 2; and a retention outcomes store containing records of implemented retention actions, customer responses, and Bayesian Network conditional probability tables from Phase 3. Each agent may access the centralized database using a defined read/write interface, with access permissions scoped to the data stores relevant to that agent's function.

### AI Agent Implementation

The AI agents in the system may be implemented using specialized Large Language Models (LLMs) and Small language Models (SLMs) trained for specific tasks within the customer retention process. These LLMs may be responsible for planning their next steps based on data received from other AI agents or from clients or customers. Each AI agent may have a specific role and set of capabilities.
Data Collection, Processing, and Quality Testing Agents (110, 120, 130, 210, 220, 230): These agents may be responsible for gathering, transforming, and validating customer data. They may select appropriate techniques from predefined sets based on the nature and quality of the input data.
Modeling Agents (140, 240): These agents may select, train, and evaluate machine learning models for churn prediction and survival analysis. They may perform automatic algorithm selection and hyperparameter tuning to optimize performance.
Explainability Agents (150): These agents may analyze trained models to produce local and global explanations of predictions. They may identify features contributing to churn predictions and broader patterns across customer segments.
Differential Diagnosis Agents (310): These agents may construct Bayesian Networks to represent relationships between churn causes and preventive actions. They may update these networks based on new information and customer responses.
Customer Interaction Agents (340): These agents may generate personalized communications and recommendations for at-risk customers. They may use specialized LLMs to craft messages that effectively convey retention offers and incentives.
Persistence Agents (170, 360): These agents may store information generated during the customer retention process in databases. They may make this information available to other agents and to humans-in-the-loop through alerts or reports.

The agents may communicate with each other through a defined protocol, passing data and instructions as needed to accomplish the overall goal of customer retention. The system may be designed to be flexible and adaptable, with agents capable of handling a wide range of customer data and business contexts.

The orchestration layer may function as a central coordinator responsible for activating, sequencing, and monitoring each AI agent within the pipeline. The orchestration layer may maintain a registry of available agents and their current operational states. Upon initiating a workflow, the orchestration layer may dispatch a structured message to the first agent in the sequence. Each structured message may conform to a defined schema comprising at least a task type identifier, a priority level, an input data payload, and a required output format specification. Upon receipt of a valid structured message, a receiving agent may execute its assigned function autonomously and return a response message conforming to the required output format. The orchestration layer may validate each outgoing message against the schema before routing it to the receiving agent, and may log the result of each agent execution for monitoring and performance tracking purposes. If an agent returns an error or fails to respond within a defined timeout, the orchestration layer may retry the task, reroute it to an alternative agent, or escalate the failure to a human operator. The orchestration layer may also dynamically adjust agent parameters, such as model hyperparameters or data thresholds, based on observed performance metrics accumulated across prior executions.

Deterministic agent sequencing may be achieved through a synchronous handshake protocol between the orchestration layer and each agent. Upon dispatching a task message to a receiving agent, the orchestration layer may enter a waiting state for that agent and may not dispatch the next task in the routing queue until one of two conditions is met: the receiving agent returns a response message that conforms to the required output schema, or the agent's timeout period expires. A schema-conformant response message may be one that includes all required output fields specified in the agent's output schema entry in the centralized schema registry, with each field value conforming to its expected data type and value range. Upon receipt of a conformant response, the orchestration layer may extract the output payload from the response message, update the pipeline state, and dispatch the next task message to the subsequent agent in the sequence. This synchronous dispatch-and-wait cycle may ensure that each agent's output is validated and available as input to the next agent before that agent begins execution, producing a deterministic execution order across the pipeline without requiring shared memory or centralized synchronization locks.

Message schema validation may be performed by the orchestration layer prior to routing each structured message to a receiving agent. Validation may comprise checking that the message includes all required fields defined in the schema, that each field value conforms to its expected data type and permissible value range, and that the task type identifier corresponds to a registered agent capable of processing that task type. A message that fails validation may be rejected by the orchestration layer without being routed to the receiving agent. Upon rejection, the orchestration layer may generate a validation error record specifying the field or fields that failed validation, and may return the error record to the originating agent or process for correction. If the originating agent is unable to produce a valid message after a configurable number of retry attempts, the orchestration layer may escalate the failure to a human operator via an alert. Valid messages may be assigned a routing priority based on the priority level field in the message schema, with higher-priority messages routed ahead of lower-priority messages in the agent's input queue. The schema definition may be stored in a centralized schema registry accessible to all agents, allowing agents to validate their own outgoing messages before submission to the orchestration layer as a pre-validation step.

The centralized schema registry may be implemented as a shared data store accessible to all agents in the pipeline, organized by agent type. Each entry in the schema registry may comprise the agent type identifier, the expected input message schema, and the expected output message schema for that agent type. When a new agent type is registered with the orchestration layer, its schema definitions may be added to the registry and made available to all other agents for pre-validation of outgoing messages. The priority-ordered routing queue may be implemented as a priority queue data structure in which each enqueued message is assigned a numeric priority value derived from the priority level field in the message schema, with lower numeric values indicating higher dispatch priority. The orchestration layer may dequeue messages in priority order, dispatching the highest-priority message to the receiving agent first. Where two messages share the same priority level, the orchestration layer may dispatch them in the order in which they were enqueued, preserving first-in, first-out ordering within each priority tier. The routing queue may be maintained in memory by the orchestration layer and may be persisted to the centralized database at configurable intervals to support recovery from orchestration layer failures.

### B. Method for Improving Customer Retention

Consistent with embodiments of the present disclosure, a method may be performed by at least one of the aforementioned modules. The method may be embodied as, for example, but not limited to, computer instructions, which, when executed, perform the method.

The orchestration layer and the schema-validated inter-agent communication protocol may each be implemented as stored executable instructions on a non-transitory computer-readable storage medium. When executed by a computing system, these instructions may cause the computing system to instantiate the orchestration layer as a software process comprising the agent registry module, message routing module, schema validation module, performance monitoring module, and priority queue manager described herein. The stored instructions may further cause the computing system to load the centralized schema registry from the non-volatile storage sub-module 561 into memory 540 at pipeline initialization, making schema definitions for each registered agent type available to the orchestration layer and to all agent processes during execution. The inter-agent communication protocol may be implemented as a set of stored message-handling routines that serialize outgoing messages into the defined schema format, validate incoming messages against the schema registry, and route validated messages to the appropriate agent process via the priority-ordered routing queue. These stored instructions may be executed on one or more computing devices 500 in a distributed configuration, with the orchestration layer instructions executing on a designated coordinating computing device 500 and the agent process instructions executing on one or more additional computing devices 500 in operative communication over a network via the communication sub-module 562.

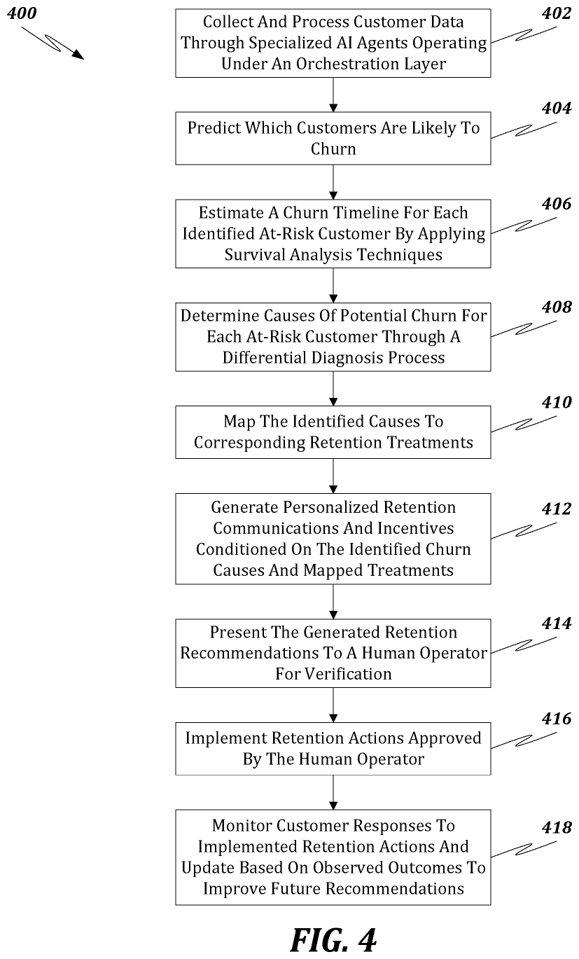

Referring to FIG. 4, a flow diagram illustrates a method 400 for improving customer retention through an agentic artificial intelligence pipeline. The method proceeds through nine sequential stages, each performed by one or more specialized AI agents coordinated by an orchestration layer. The orchestration layer dispatches schema-validated structured messages to each agent in sequence and enters a waiting state after each dispatch until the receiving agent returns a conformant response, producing deterministic execution order without requiring centralized synchronization locks.

At stage 402, the method 400 collects and processes customer data through a plurality of specialized AI agents operating under the orchestration layer. The orchestration layer activates the Data Collection Agent 110, the Data Processing Agent 120, and the Data Quality Agent 130 in sequence, coordinating inter-agent communication via the schema-validated inter-agent communication protocol.

The Data Collection Agent 110 gathers customer data from multiple heterogeneous sources including CRM systems, transaction databases, customer interaction logs, email engagement platforms, support ticketing systems, and Net Promoter Score survey tools. Each source is accessed through a configurable source-specific connector. For CRM systems, the agent connects via REST API or native SDK integrations authenticated using OAuth 2.0 tokens or API keys stored in a secure credential store. For transaction databases, the agent connects via JDBC or ODBC drivers and executes parameterized queries to extract records within a configurable lookback window. For customer interaction logs, the agent ingests structured log files or streaming event data via message queue subscriptions. Upon collection, data from each source is normalized into a common internal schema comprising at least a customer identifier, a timestamp, a data category, and a value field. The agent logs the source, record count, and collection timestamp for each data pull to support auditability and data lineage tracking.

In one example embodiment, a subscription-based software company may configure the Data Collection Agent 110 to connect to a Salesforce CRM instance via REST API, a PostgreSQL billing database via JDBC, and a Zendesk support ticketing system via its native API. The agent may collect customer usage metrics, billing records, and support ticket histories within a ninety-day lookback window, normalizing all records into the common internal schema before forwarding the combined dataset to the Data Processing Agent 120.

The Data Processing Agent 120 receives the normalized dataset and applies transformation, normalization, and feature engineering operations to produce a processed feature matrix. These operations may include handling missing values through imputation, normalizing numerical features to a common scale, encoding categorical variables using one-hot or ordinal encoding, and creating derived features predictive of churn such as rolling averages of usage frequency or rate-of-change metrics for support ticket volume. The agent selects appropriate processing techniques from a predefined set based on the nature and quality of the input data and forwards the processed feature matrix to the Data Quality Agent 130.

In one example embodiment, a subscription-based software company may provide a normalized dataset comprising daily active usage hours, monthly billing amounts, support ticket submission counts, and feature adoption flags for each customer. The Data Processing Agent 120 may impute missing values in the daily active usage hours field using the customer's own historical median, apply min-max normalization to the monthly billing amount field, and apply one-hot encoding to a categorical plan tier field comprising three categories. The agent may additionally engineer derived features comprising a thirty-day rolling average of daily active usage hours, a rate-of-change metric computed as the difference between the current month's usage average and the prior month's usage average divided by the prior month's average, and a support ticket acceleration metric computed as the difference between the current week's ticket count and the prior week's ticket count. These derived features may be appended to the feature matrix and forwarded to the Data Quality Agent 130 for quality testing.

In another example embodiment, a telecommunications provider may provide a normalized dataset comprising call detail records, data usage volumes, billing amounts, and customer service interaction counts. The Data Processing Agent 120 may apply z-score normalization to the data usage volume field, encode a categorical contract type field using ordinal encoding reflecting contract length, and engineer derived features comprising a seven-day rolling average of data usage volume, a billing amount deviation metric computed as the difference between the current month's billing amount and the customer's twelve-month average, and a customer service interaction frequency metric computed as the number of interactions in the preceding thirty days divided by the customer's historical monthly average. These derived features may be appended to the feature matrix and forwarded to the Data Quality Agent 130.

The Data Quality Agent 130 applies a defined set of automated quality tests to the processed feature matrix. Multicollinearity detection is performed by computing the variance inflation factor for each feature, with features exceeding a configurable threshold flagged for removal or consolidation. Target leakage detection is performed by computing the point-biserial correlation between each feature and the churn label, with features exhibiting a correlation above a configurable threshold excluded from model training. Feature correlation analysis identifies pairs of features with a Pearson correlation coefficient exceeding a configurable threshold, with one feature from each highly correlated pair removed to reduce redundancy. If any test produces a failure, the Data Quality Agent 130 generates a quality report specifying the failing features and the nature of each failure and returns the dataset to the Data Processing Agent 120 with remediation instructions. This feedback loop continues until all quality tests pass or a configurable maximum number of iterations is reached, at which point the system escalates to a human operator. Upon passing all quality tests, the validated feature matrix is forwarded to the downstream modeling agents.

At stage 404, the method 400 predicts which customers are likely to churn by executing the Automatic Custom Churn Modeling Agent 140 and the Custom Churn Explainability Agent 150.

The Automatic Custom Churn Modeling Agent 140 receives the validated feature matrix and evaluates candidate machine learning algorithms using stratified k-fold cross-validation, where k defaults to five and may be adjusted based on dataset size. For datasets with fewer than a defined minimum number of samples per class, the agent applies leave-one-out cross-validation or a bootstrapped resampling strategy. The primary performance metric for algorithm selection is the area under the receiver operating characteristic curve, computed as the mean across all cross-validation folds. Where class imbalance is detected, the agent additionally evaluates the F1 score and the precision-recall area under the curve as secondary metrics. Candidate algorithms may include gradient boosting methods such as XGBoost and CatBoost, ensemble methods such as Random Forest, and logistic regression models. The algorithm achieving the highest mean area under the receiver operating characteristic curve across folds is selected for full training on the complete dataset. Where two or more algorithms achieve statistically equivalent scores within a defined tolerance, the agent selects the algorithm with the lowest computational complexity to favor deployment efficiency. The selected algorithm is then trained with automatic hyperparameter tuning, and the agent generates a model performance report comprising cross-validation scores, confusion matrix statistics, and feature importance rankings.

In one example embodiment, a medical subscription service with a dataset of approximately two thousand patient records and a class imbalance ratio of approximately ten to one between retained and churned patients may cause the Automatic Custom Churn Modeling Agent 140 to apply a bootstrapped resampling strategy and evaluate CatBoost, Random Forest, and logistic regression as candidate algorithms. The agent may select CatBoost based on its achieving the highest mean area under the receiver operating characteristic curve across bootstrap folds and may apply Bayesian hyperparameter optimization to tune the learning rate, maximum tree depth, and number of estimators.

In another example embodiment, an e-commerce retailer with a dataset of fifty thousand customer records and moderate class balance may cause the Automatic Custom Churn Modeling Agent 140 to apply five-fold stratified cross-validation and evaluate XGBoost among other explainable training algorithms. The agent may select XGBoost based on its achieving the highest mean area under the receiver operating characteristic curve and may apply grid search with cross-validation to tune the subsample ratio, column sample ratio, and regularization parameters.

The Custom Churn Explainability Agent 150 receives the trained model artifact and the validated feature matrix and applies SHapley Additive exPlanations to compute a SHAP value for each feature for each individual customer prediction. The SHAP value for a feature represents the marginal contribution of that feature to the difference between the customer's predicted churn probability and the baseline prediction across the training dataset. Local explanation reports comprise, for each at-risk customer, a ranked list of features ordered by absolute SHAP value, the direction of each feature's contribution, and the customer's actual feature value alongside the population median for reference. Global explanation reports comprise a ranked list of features by mean absolute SHAP value, a summary of the distribution of SHAP values for each top-ranked feature across customer segments, and a set of partial dependence plots illustrating the relationship between each top feature and predicted churn probability. Both local and global explanation reports are stored by the Phase 1 Persistence Agent 170 in the centralized database and made available to downstream agents in Phase 3 as inputs to the differential diagnosis process.

The Custom Churn Model Deployer 160 packages the trained model artifact and explanation reports into a deployable inference service exposing API endpoints for churn prediction requests. The Phase 1 Persistence Agent 170 stores all model artifacts, prediction scores, and explanation reports in the centralized database for access by downstream agents in Phases 2 and 3.

At stage 406, the method 400 estimates a churn timeline for each identified at-risk customer by applying survival analysis techniques through the Customer Survival Analysis Agent 240.

The Customer Survival Analysis Agent 240 retrieves the churn probability scores and customer risk profiles stored by the Phase 1 Persistence Agent 170 in the centralized database. The agent also collects fresh customer data through the Data Collection Agent 210, Data Processing Agent 220, and Data Quality Agent 230 of the Phase 2 subsystem, which apply the same collection, transformation, and quality testing operations as their Phase 1 counterparts, additionally incorporating the churn probability scores and explainability outputs from Phase 1.

The Customer Survival Analysis Agent 240 defines the event variable as the occurrence of customer churn, represented as a binary indicator, and the time variable as the duration of the customer's relationship with the business measured in days or months from the customer's start date to either the churn event or the observation cutoff date. Customers who have not churned by the observation cutoff date are treated as right-censored observations. The Kaplan-Meier estimator is fitted to the population of at-risk customers identified in Phase 1, producing a step-function estimate of the survival probability at each observed event time. For each individual at-risk customer, the agent applies the fitted population-level survival function as a baseline and adjusts the predicted survival curve using the customer's individual feature values and churn probability score from Phase 1 to produce a customer-specific survival estimate. The output for each customer comprises a predicted median survival time representing the time at which the customer's survival probability falls below 0.5, a predicted churn window defined by the interquartile range of the survival distribution, and a survival curve plot stored in the centralized database for review by human operators.

Alternative survival analysis techniques that may be applied include the Cox Proportional Hazards model, which allows for examination of the relationship between survival time and predictor variables, and parametric models such as the Weibull or exponential distributions, which may be selected by the agent when the data characteristics support a parametric assumption.

In one example embodiment, a telecommunications provider may have a customer base in which the median time to churn following initial signs of dissatisfaction is approximately ninety days. The Customer Survival Analysis Agent 240 may fit a Kaplan-Meier estimator to the population of at-risk customers identified in Phase 1 and may generate customer-specific survival estimates adjusted by each customer's churn probability score and feature values. For a customer with a churn probability score of 0.82 and declining usage metrics, the agent may produce a predicted median survival time of thirty-one days and a predicted churn window of twenty to forty-five days, indicating high urgency for retention intervention.

In another example embodiment, a subscription-based software company may have a smaller dataset in which the Cox Proportional Hazards model is selected by the Customer Survival Analysis Agent 240 based on the availability of time-varying covariates such as monthly active usage hours and support ticket submission frequency. The agent may generate a predicted churn window for each at-risk customer and may store survival curve plots in the centralized database for review by account managers through the human verification interface.

The composite urgency score for each at-risk customer is computed as a weighted combination of the churn probability score from Phase 1 and the inverse of the predicted time-to-churn from Phase 2, such that customers with both a high churn probability and a short predicted time-to-churn receive the highest urgency scores. The weights applied to each component are configurable by the business operator and default to equal weighting. Based on the composite urgency score, each at-risk customer is assigned to one of a plurality of urgency tiers. High-urgency customers predicted to churn within a short defined window receive immediate outreach through direct channels such as phone or personalized email. Lower-urgency customers receive scheduled outreach through lower-cost channels. The Phase 2 Precedence Alarm Agent 250 monitors each customer's predicted time-to-churn against a configurable urgency threshold and dispatches alerts comprising the customer identifier, predicted churn probability score, estimated time-to-churn, identified churn cause categories, and recommended retention action to designated stakeholders through operator-configured notification channels including email, SMS, and in-application dashboard interfaces. The Phase 2 Persistence Agent 260 stores all survival analysis outputs, urgency tier assignments, composite urgency scores, and survival curve plots in the centralized database for use by the downstream agents in Phase 3.

At stage 408, the method 400 determines the causes of potential churn for each at-risk customer through a differential diagnosis process executed by the Customer Differential Diagnosis Agent 310.

The Customer Differential Diagnosis Agent 310 retrieves the ranked list of at-risk customers from the centralized database, ordered by composite urgency score, and initiates a differential diagnosis for each customer by performing probabilistic inference over a Bayesian Network comprising churn cause nodes and retention treatment nodes. The Bayesian Network is structured as a directed acyclic graph in which nodes represent churn cause categories and retention treatment categories, and directed edges represent conditional probabilistic dependencies between them. Churn cause nodes include, but are not limited to, product dissatisfaction, pricing sensitivity, competitive offers, service quality issues, and life event triggers. Each cause node is associated with a set of observable evidence variables drawn from customer data, such as declining feature usage frequency as evidence for product dissatisfaction, or increased support ticket volume as evidence for service quality issues. Symptoms may also be drawn from domain experts and business owners, including metrics such as Net Promoter Score and Voice of Customer data when available from the Data Collection Agent 210.

The Customer Differential Diagnosis Agent 310 performs probabilistic inference over the Bayesian Network using observed customer evidence to compute a posterior probability distribution over cause nodes, identifying the most probable causes of churn for each individual customer. The agent outputs, for each customer, a posterior probability distribution over churn cause categories, transmitted as a structured message payload to the Customer Churn Shift Agent 320 and the Customer Treatment Prescriber Agent 330.

In one example embodiment, an e-commerce retailer may configure the Bayesian Network to include cause nodes for price sensitivity, product quality dissatisfaction, shipping experience issues, and reduced purchase intent following a life event. For a customer exhibiting a pattern of cart abandonment at the payment stage combined with a low Net Promoter Score response citing price as a concern, the Customer Differential Diagnosis Agent 310 may compute a posterior probability of 0.74 for the price sensitivity cause node, 0.15 for the product quality dissatisfaction node, and lower probabilities for remaining nodes, identifying price sensitivity as the most probable cause of potential churn for that customer.

In another example embodiment, a medical subscription service may configure the Bayesian Network to include cause nodes for scheduling inconvenience, perceived lack of health benefit, cost burden, and reduced engagement following an initial enrollment period. For a patient who has missed two consecutive appointments and has not accessed any digital health resources in the preceding thirty days, the Customer Differential Diagnosis Agent 310 may compute a posterior probability of 0.61 for the scheduling inconvenience node and 0.28 for the reduced engagement node, identifying scheduling inconvenience as the primary probable cause of potential disengagement.

At stage 410, the method 400 maps the identified churn causes to corresponding retention treatments through the Customer Treatment Prescriber Agent 330, operating in coordination with the Customer Churn Shift Agent 320.

The Customer Churn Shift Agent 320 monitors incoming data streams for new customer information that may alter the differential diagnosis for one or more at-risk customers. New information may include updated customer interaction records, new support ticket submissions, changes in product usage frequency, updated Net Promoter Score responses, or new Voice of Customer data received after the initial diagnostic cycle. Upon detecting new information for a customer, the Customer Churn Shift Agent 320 updates the evidence variables associated with that customer's Bayesian Network inference and submits a re-diagnosis request to the Customer Differential Diagnosis Agent 310. The Customer Differential Diagnosis Agent 310 recomputes the posterior probability distribution over churn cause nodes using the updated evidence, producing a revised ranked list of probable churn causes. A cause is considered ruled in when its posterior probability exceeds a configurable threshold and ruled out when its posterior probability falls below a configurable minimum threshold, at which point it is removed from the active cause list for that customer. If the revised diagnosis results in a change to the highest-probability cause category, the Customer Churn Shift Agent 320 notifies the Customer Treatment Prescriber Agent 330 to generate an updated treatment recommendation based on the new diagnosis.

The Customer Treatment Prescriber Agent 330 receives the posterior probability distribution over churn cause nodes from the Customer Differential Diagnosis Agent 310 and traverses the directed edges of the Bayesian Network from the highest-probability cause nodes to identify the treatment nodes with the highest conditional probability of success. Retention treatment nodes include, but are not limited to, personalized discount offers, product education campaigns, service upgrade proposals, contract renegotiation, and proactive customer success outreach. Directed edges from cause nodes to treatment nodes encode the conditional probability that a given treatment is effective given a particular cause, based on historical retention outcome data. The Customer Treatment Prescriber Agent 330 outputs a ranked list of recommended treatments for each at-risk customer, transmitted as a structured message payload to the Customer Interaction Recommender Agent 340.

In one example embodiment, for the e-commerce customer identified at stage 408 as exhibiting a posterior probability of 0.74 for the price sensitivity cause node, the Customer Treatment Prescriber Agent 330 may traverse the Bayesian Network edges from the price sensitivity node and identify a personalized discount offer as the treatment node with the highest conditional probability of success at 0.68, followed by a loyalty rewards enrollment offer at 0.21. The agent may output a ranked treatment list with the personalized discount offer ranked first and the loyalty rewards enrollment ranked second.

In another example embodiment, for the medical subscription patient identified at stage 408 as exhibiting a posterior probability of 0.61 for the scheduling inconvenience node, the Customer Treatment Prescriber Agent 330 may identify a modified care schedule proposal as the treatment node with the highest conditional probability of success at 0.59, followed by a telehealth appointment option at 0.31. The agent may output a ranked treatment list with the modified care schedule proposal ranked first.

At stage 412, the method generates personalized retention communications and incentives through the Customer Interaction Recommender Agent 340, which constructs a structured prompt and submits it to a specialized Large Language Model.

The Customer Interaction Recommender Agent 340 receives the ranked treatment recommendations from the Customer Treatment Prescriber Agent 330 and constructs a structured prompt comprising the customer's churn probability score, predicted churn timeline, identified churn cause category, ranked treatment recommendations, and a summary of the customer's historical engagement patterns. Historical engagement patterns include metrics such as average response rate to prior communications, preferred contact times, previously accepted or rejected offers, and channel interaction history. The preferred communication channel for each customer is determined by analyzing the channel through which the customer has historically exhibited the highest engagement rate, or by retrieving a channel preference explicitly recorded in the customer's profile.

The Large Language Model generates a personalized retention communication adapted in tone, format, and incentive type based on these inputs. A customer diagnosed with pricing sensitivity receives a communication in a direct, value-focused tone offering a discounted rate, delivered via the customer's preferred channel. A customer diagnosed with product dissatisfaction receives a communication offering a product education session or a feature upgrade, adapted in tone to be supportive and informative. The generated communication is formatted for the target channel, with email communications including a subject line and structured body, and SMS communications condensed to a defined character limit. The generated communication is transmitted as a structured message payload to the human verification interface.

In one example embodiment, for the e-commerce customer identified as price-sensitive with a preferred channel of email and a historical response rate of 34 percent to promotional email communications, the Customer Interaction Recommender Agent 340 may construct a prompt specifying the price sensitivity cause, the personalized discount offer treatment ranked first, and the customer's email engagement history. The Large Language Model may generate a personalized email communication with a subject line referencing the customer's most recently browsed product category, a body paragraph acknowledging the customer's loyalty and presenting a time-limited discount code, and a call-to-action button formatted for the email channel.

In another example embodiment, for the medical subscription patient identified as experiencing scheduling inconvenience with a preferred channel of SMS and a historical response rate of 61 percent to SMS outreach, the Customer Interaction Recommender Agent 340 may construct a prompt specifying the scheduling inconvenience cause, the modified care schedule proposal treatment ranked first, and the patient's SMS engagement history. The Large Language Model may generate an SMS communication condensed to within the defined character limit, offering the patient a link to a self-service scheduling tool and a brief message acknowledging the flexibility of the modified care schedule option.

At stage 414, the method 400 presents the generated retention recommendations to a human operator for verification prior to implementation through the human verification interface.

The human verification interface receives the generated retention recommendations from the Customer Interaction Recommender Agent 340 and presents each recommendation to a human operator through a dashboard or review queue. For each at-risk customer, the interface displays the customer's predicted churn probability score, estimated churn timeline, identified churn cause categories ranked by posterior probability, and the proposed retention action including the generated personalized communication and incentive. The operator may take one of three actions for each recommendation: approve, modify, or reject.

If the operator approves a recommendation, the human verification interface routes the approved communication to the designated delivery channel for transmission to the customer. If the operator modifies a recommendation, the interface allows the operator to edit the communication text, adjust the incentive type or value, or change the delivery channel, after which the modified recommendation is submitted for delivery. If the operator rejects a recommendation, the system logs the rejection with an optional reason code and flags the customer record for manual follow-up or re-evaluation in a subsequent diagnostic cycle.

The interface also allows the operator to set a bulk approval threshold, whereby recommendations with a churn probability score above a configurable threshold and a composite urgency score above a configurable minimum may be automatically approved without individual review, subject to operator configuration. This bulk approval mechanism reduces the volume of individual review actions required of the operator while preserving operator control over the approval policy parameters.

In one example embodiment, an account manager at a subscription-based software company may review a queue of fifteen at-risk customer recommendations presented through the human verification interface. The manager may individually approve twelve recommendations, modify two recommendations by adjusting the discount value from fifteen percent to twenty percent for customers with longer tenure, and reject one recommendation for a customer already engaged in a separate renewal negotiation. The manager may additionally configure a bulk approval threshold of 0.85 churn probability and a composite urgency score minimum of 0.75, enabling automatic approval of future high-urgency recommendations meeting both criteria without individual review.

In another example embodiment, a customer success team lead at a telecommunications provider may review a dashboard presenting fifty at-risk customer recommendations ranked by composite urgency score. The team lead may configure a bulk approval threshold enabling automatic approval of all recommendations in the high-urgency tier, while retaining individual review for medium-urgency and low-urgency tier recommendations. For three medium-urgency recommendations, the team lead may modify the proposed delivery channel from email to SMS based on knowledge of those customers' recent channel preferences not yet reflected in the engagement history data.

At stage 416, the method 400 implements only the retention actions approved by the human operator. The human verification interface routes each approved or modified communication to the designated delivery channel for transmission to the customer. Approved email communications are transmitted through the configured email delivery service. Approved SMS communications are transmitted through the configured SMS gateway. Approved in-application notifications are delivered through the configured application notification service. The Persistence Agent 360 stores the operator's decision and the final communication for each customer, including the delivery channel, transmission timestamp, and the content of the communication as transmitted.

In one example embodiment, following approval by the account manager at the subscription-based software company, twelve personalized email communications are routed by the human verification interface to the company's configured email delivery service and transmitted to the respective at-risk customers. Two modified communications with adjusted discount values are similarly transmitted. The Persistence Agent 360 records the transmission timestamp, delivery channel, operator decision, and communication content for each of the fourteen transmitted communications, and flags the one rejected customer record for manual follow-up.

In another example embodiment, following bulk approval configuration by the customer success team lead at the telecommunications provider, all high-urgency tier communications are automatically routed to the SMS gateway and transmitted without individual review. Medium-urgency and low-urgency tier communications approved or modified individually by the team lead are routed to their respective delivery channels. The Persistence Agent 360 records all delivery records and operator decisions in the retention outcomes store within the centralized database.

At stage 418, the method 400 monitors customer responses to implemented retention actions over a configurable observation window and updates the Bayesian Network conditional probability tables based on observed outcomes to improve future retention recommendations. This stage is executed by the Relief Retention Analytics Agent 350 in coordination with the Persistence Agent 360.

The Relief Retention Analytics Agent 350 retrieves from the Persistence Agent 360 the records of implemented retention actions and their associated outcomes over a defined observation window following each intervention. For each customer record, the agent identifies the churn cause that was diagnosed, the treatment that was applied, and whether the customer was successfully retained within the observation window. The agent uses this outcome data to update the conditional probability tables of the Bayesian Network using a Bayesian update rule, incrementing the probability weight of treatment-cause pairs associated with successful retention outcomes and decrementing the weight of pairs associated with unsuccessful outcomes. The magnitude of each update is scaled by a configurable learning rate to prevent overfitting to recent outcomes. Updated conditional probability tables are persisted to the centralized database by the Persistence Agent 360 and loaded by the Customer Differential Diagnosis Agent 310 at the start of each new diagnostic cycle, closing the feedback loop and enabling the Phase 3 subsystem to improve the precision of its retention recommendations over successive pipeline executions.

The Relief Retention Analytics Agent 350 also aggregates retention outcome records across a configurable historical window and applies pattern detection techniques to identify systematic relationships between customer attributes, churn causes, applied treatments, and retention outcomes. Pattern detection comprises computing success rates for each treatment-cause pair across customer segments defined by attributes such as tenure, product tier, and revenue contribution. The agent identifies treatments that consistently underperform across one or more customer segments and flags these treatment-cause pairs for review. The agent also identifies customer attribute combinations associated with high retention success rates and generates a summary report of these patterns for use by the orchestration layer in adjusting agent parameters.

If implemented retention strategies fail and a customer churns, the Relief Retention Analytics Agent 350 reviews the effectiveness of the applied incentives and treatments for similar customers, identifies patterns in unsuccessful retention attempts, and updates the Bayesian Network to reduce the conditional probability weight of the treatment-cause pairs associated with the failed interventions. The Persistence Agent 360 stores all Phase 3 outputs, including differential diagnosis results, treatment recommendations, generated communications, operator decisions, delivery records, retention outcomes, and updated Bayesian Network conditional probability tables, in the retention outcomes store within the centralized database.

In one example embodiment, a subscription-based software company may configure a thirty-day observation window following each transmitted retention communication. After thirty days, the Relief Retention Analytics Agent 350 may retrieve outcome records for the fourteen customers who received communications at stage 416 and determine that eleven customers renewed their subscriptions and three customers churned despite the intervention. The agent may apply a Bayesian update rule with a learning rate of 0.1 to increment the conditional probability weight of the personalized discount offer treatment for the price sensitivity cause node based on the eleven successful outcomes, and to decrement the weight of that treatment for the three unsuccessful outcomes. Updated conditional probability tables may be persisted to the centralized database and loaded by the Customer Differential Diagnosis Agent 310 at the start of the next diagnostic cycle.

In another example embodiment, a telecommunications provider may configure a fourteen-day observation window and may find that SMS communications generated for customers diagnosed with service quality issues achieved a retention success rate of 38 percent, compared to a 71 percent success rate for customers diagnosed with pricing sensitivity. The Relief Retention Analytics Agent 350 may flag the service quality issue cause node and its associated treatment mappings for review, generate a summary report identifying the underperformance pattern, and update the Bayesian Network conditional probability tables to reduce the weight of the current treatment-cause pairs for service quality issues. The orchestration layer may use the summary report to adjust the Customer Treatment Prescriber Agent 330 parameters for the service quality issue cause category in subsequent diagnostic cycles, directing the agent to explore alternative treatment nodes with higher historical success rates for that cause category.

### IV. HARDWARE ARCHITECTURE

Embodiments of the present disclosure provide a hardware and software platform operative as a distributed system of modules and computing elements.

The system may be embodied as, for example, but not be limited to, a website, a web application, a desktop application, a backend application, and a mobile application compatible with a computing device 500. The computing device 500 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
The system may be hosted on a centralized server or a cloud computing service. Although methods have been described to be performed by a computing device 500, it should be understood that, in some embodiments, different operations may be performed by a plurality of the computing devices 500 in operative communication on at least one network.

Embodiments of the present disclosure may comprise a system having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for redundancy, high availability, and/or performance purposes. The combination of the presently disclosed units is configured to perform the stages of any method disclosed herein.

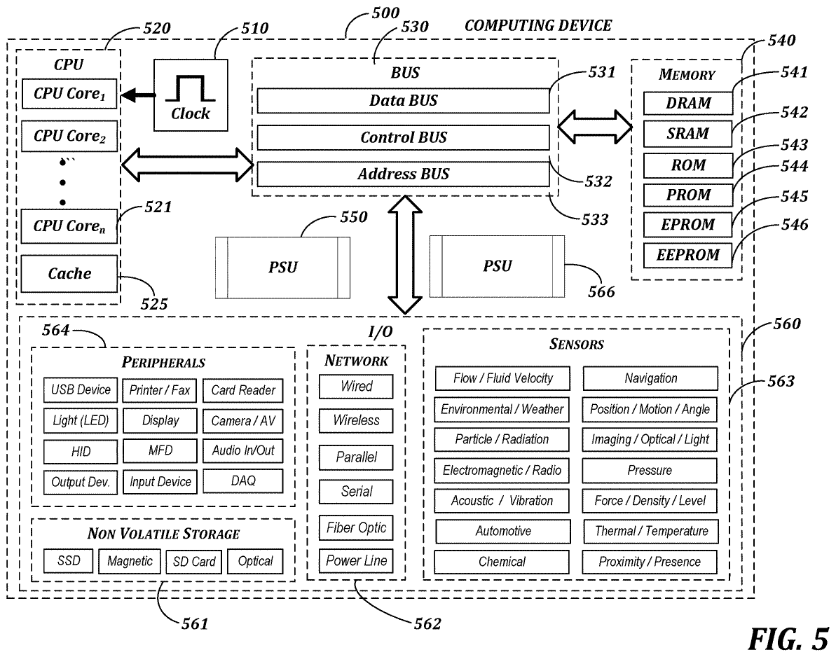

FIG. 5 is a block diagram of a system including computing device 500. Consistent with an embodiment of the disclosure, the aforementioned CPU 520, the bus 530, the memory unit 540, a PSU 550, and the plurality of I/O units 560 may be implemented in a computing device, such as computing device 500 of FIG. 5. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, and the memory unit 540, consistent with embodiments of the disclosure.

At least one computing device 500 may be embodied as any of the computing elements illustrated in all of the attached figures. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In some configurations, the computing device 500 may include at least one clock module 510, at least one CPU 520, at least one bus 530, and at least one memory unit 540, at least one GPU 566, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

In a system consistent with an embodiment of the disclosure, the computing device 500 may include the clock module 510, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 520, the central component of modern computers, which relies on a clock signal. The clock 510 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 500 may use a “clock multiplier” which multiplies a lower frequency external clock to the appropriate clock rate of the CPU 520. This allows the CPU 520 to operate at a much higher frequency than the rest of the computing device 500, which affords performance gains in situations where the CPU 520 does not need to wait on an external factor (like memory 540 or input/output 560). Some embodiments of the clock 510 may include dynamic frequency change, where the time between clock edges can vary widely from one edge to the next and back again.

In a system consistent with an embodiment of the disclosure, the computing device 500 may include the CPU 520 comprising at least one CPU Core 521. In other embodiments, the CPU 520 may include a plurality of identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU 520 reads and executes program instructions which may be used across many application domains, for example, but not limited to, general purpose computing, embedded computing, network computing, digital signal processing (DSP), and graphics processing (GPU) 566. The GPU 566 contains multiple cores and can perform parallel processing and perform complex calculations simultaneously designed for AI processing workloads. The GPU 566 communicates with Main Memory 530 and CPU 520 using the PCI Bus 565. The CPU 520 may run multiple instructions on separate CPU cores 521 simultaneously. The CPU 520 may be integrated into at least one of a single integrated circuit die, and multiple dies in a single chip package. The single integrated circuit die and/or the multiple dies in a single chip package may contain a plurality of other elements of the computing device 500, for example, but not limited to, the clock 510, the bus 530, the memory 540, and I/O 560.

The CPU 520 may contain cache 522 such as but not limited to a level 1 cache, a level 2 cache, a level 3 cache, or combinations thereof. The cache 522 may or may not be shared amongst a plurality of CPU cores 521. The cache 522 sharing may comprise at least one of message passing and inter-core communication methods used for the at least one CPU Core 521 to communicate with the cache 522. The inter-core communication methods may comprise, but not be limited to, bus, ring, two-dimensional mesh, and crossbar. The aforementioned CPU 520 may employ symmetric multiprocessing (SMP) design.

The one or more CPU cores 521 may comprise soft microprocessor cores on a single field programmable gate array (FPGA), such as semiconductor intellectual property cores (IP Core). The architectures of the one or more CPU cores 521 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the computing device 500, and/or the plurality of computing devices 500. The aforementioned communication system will be known to a person having ordinary skill in the art as a bus 530. The bus 530 may embody internal and/or external hardware and software components, for example, but not limited to a wire, an optical fiber, various communication protocols, and/or any physical arrangement that provides the same logical function as a parallel electrical bus. The bus may comprise at least one of a parallel bus, wherein the parallel bus carries data words in parallel on multiple wires; and a serial bus, wherein the serial bus carries data in bit-wise serial form. The bus 530 may embody a plurality of topologies, for example, but not limited to, a multidrop/electrical parallel topology, a daisy chain topology, and connected by switched hubs, such as a USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 500 may employ hardware integrated circuits that store information for immediate use in the computing device 500, known to persons having ordinary skill in the art as primary storage or memory 540. The memory 540 operates at high speed, distinguishing it from the non-volatile storage sub-module 561, which may be referred to as secondary or tertiary storage, which provides relatively slower-access to information but offers higher storage capacity. The data contained in memory 540, may be transferred to secondary storage via techniques such as, but not limited to, virtual memory and swap. The memory 540 may be associated with addressable semiconductor memory, such as integrated circuits consisting of silicon-based transistors, that may be used as primary storage or for other purposes in the computing device 500. The memory 540 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 500 may employ a communication system between an information processing system, such as the computing device 500, and the outside world, for example, but not limited to, human, environment, and another computing device 500. The aforementioned communication system may be known to a person having ordinary skill in the art as an Input/Output (I/O) module 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces with a plurality of hardware, such as, but not limited to, non-volatile storage 561, communication devices 562, sensors 563, and peripherals 564. The plurality of hardware is used by at least one of, but not limited to, humans, the environment, and another computing device 500 to communicate with the present computing device 500. The I/O module 560 may comprise a plurality of forms, for example, but not limited to channel I/O, port mapped I/O, asynchronous I/O, and Direct Memory Access (DMA).

Consistent with the embodiments of the present disclosure, the aforementioned computing device 500 may employ a non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 540. The non-volatile storage sub-module 561 may not lose data when power is removed and may be orders of magnitude less costly than storage used in memory 540. Further, the non-volatile storage sub-module 561 may have a slower speed and higher latency than in other areas of the computing device 500. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 500 may employ a communication sub-module 562 as a subset of the I/O module 560, which may be referred to by a person having ordinary skill in the art as at least one of, but not limited to, a computer network, a data network, and a network. The network may allow computing devices 500 to exchange data using connections, which may also be known to a person having ordinary skill in the art as data links, which may include data links between network nodes. The nodes may comprise networked computer devices 500 that may be configured to originate, route, and/or terminate data. The nodes may be identified by network addresses and may include a plurality of hosts consistent with the embodiments of a computing device 500. Examples of computing devices that may include a communication sub-module 562 include, but are not limited to, personal computers, phones, servers, drones, and networking devices such as, but not limited to, hubs, switches, routers, modems, and firewalls.

Two nodes can be considered networked together when one computing device 500 can exchange information with the other computing device 500, regardless of any direct connection between the two computing devices 500. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 562 may comprise a plurality of size, topology, traffic control mechanisms and organizational intent policies. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 500 may employ a sensors sub-module 563 as a subset of the I/O 560. The sensors sub-module 563 comprises at least one of the device, module, or subsystem whose purpose is to detect events or changes in its environment and send the information to the computing device 500. Sensors may be sensitive to the property they are configured to measure, may not be sensitive to any property not measured but be encountered in its application, and may not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ a peripherals sub-module 564 as a subset of the I/O 560. The peripheral sub-module 564 comprises ancillary devices uses to put information into and get information out of the computing device 500. There are 3 categories of devices comprising the peripheral sub-module 564, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 564:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 500 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 562), data storage devices (non-volatile storage 561), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. CONCLUSION

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A computer-implemented method for improving customer retention through an agentic artificial intelligence pipeline that reduces manual data science overhead, increases churn prediction accuracy through automated algorithm selection and cross-validated model evaluation, and generates personalized retention communications without human authoring, comprising:
collecting and processing customer data through a plurality of specialized artificial intelligence (AI) agents operating under an orchestration layer that coordinates inter-agent communication via a structured data protocol;
predicting which customers are likely to churn by executing a custom churn modeling agent that automatically selects a machine learning algorithm based on data characteristics, trains the selected algorithm with automatic hyperparameter tuning, and generates local and global explanations for each churn prediction;
estimating a churn timeline for each identified at-risk customer by applying survival analysis techniques, including Kaplan-Meier estimators, to predict when each customer is likely to churn;
determining causes of potential churn for each at-risk customer through a differential diagnosis process comprising constructing a Bayesian Network representing probabilistic relationships between churn causes and retention treatments, identifying probable causes of churn for the individual customer, and mapping the identified causes to corresponding retention treatments;
generating personalized retention communications and incentives through a Large Language Model agent conditioned on the identified churn causes and mapped treatments;
presenting the generated retention recommendations to a human operator for verification prior to implementation;
implementing only the retention actions approved by the human operator; and
monitoring customer responses to implemented retention actions and updating the Bayesian Network based on observed outcomes to improve future retention recommendations.

2. The method of claim 1, wherein collecting and processing customer data comprises:
gathering data from multiple sources through a data collection agent;
transforming raw data through a data processing agent; and
validating data quality through a data quality agent.

3. The method of claim 1, wherein predicting which customers are likely to churn further comprises evaluating a plurality of candidate machine learning algorithms comprising at least gradient boosting, random forest, and logistic regression models, and selecting the algorithm that achieves a highest cross-validated performance metric on the customer dataset.

4. The method of claim 1, wherein constructing the Bayesian Network comprises defining nodes representing at least product dissatisfaction, pricing sensitivity, competitive offers, service quality issues, and life event triggers as churn cause categories, and defining directed edges representing conditional dependencies between each cause category and one or more corresponding retention treatments.

5. The method of claim 1, wherein generating personalized retention communications further comprises conditioning the Large Language Model agent on a preferred communication channel for each customer and adapting tone, format, and incentive type based on the customer's identified churn cause and historical engagement patterns.

6. The method of claim 1, wherein monitoring customer responses comprises:
tracking customer behavior following retention actions;
analyzing patterns in successful and unsuccessful retention attempts; and
updating Bayesian Networks to improve future retention recommendations.

7. The method of claim 1, wherein presenting the generated retention recommendations to the human operator comprises displaying, for each at-risk customer, the predicted churn probability, estimated churn timeline, identified churn causes, and proposed retention action, and wherein the operator may approve, modify, or reject each recommendation individually.

8. The method of claim 1, wherein updating the Bayesian Network comprises:
tracking customer behavior following each implemented retention action over a defined observation window;
computing updated conditional probability distributions for churn causes based on observed retention outcomes; and
adjusting treatment mappings within the Bayesian Network to increase the probability weight of treatments associated with successful retention outcomes.

9. The method of claim 1, wherein the orchestration layer maintains a centralized schema registry storing message schema definitions for each agent type in the pipeline, and wherein the orchestration layer assigns each validated message a routing priority derived from the priority level field in the message schema and places the message in a priority-ordered routing queue before dispatching it to the receiving agent.

10. A system for customer retention through agentic artificial intelligence, comprising:
an orchestration layer configured to activate, coordinate, and monitor a plurality of specialized AI agents via a structured inter-agent communication protocol;
a data processing subsystem comprising AI agents configured to collect customer data from multiple sources, transform the collected data for analysis, and validate data quality through automated quality tests;
a churn prediction subsystem comprising AI agents configured to automatically select and train machine learning models for churn prediction and generate local and global explanations for each prediction;
a churn timeline subsystem comprising AI agents configured to apply survival analysis techniques, including Kaplan-Meier estimators, to estimate when each at-risk customer is likely to churn;
a retention planning subsystem comprising AI agents configured to construct Bayesian Networks representing probabilistic relationships between churn causes and retention treatments, identify probable churn causes for individual customers, and map identified causes to corresponding treatments;
a customer interaction subsystem comprising a Large Language Model agent configured to generate personalized retention communications and incentives conditioned on identified churn causes and mapped treatments;
a human verification interface configured to present retention recommendations to a human operator for approval prior to implementation; and
a persistence subsystem comprising AI agents configured to store churn prediction data and models, issue alerts for imminent churn risks, and update the Bayesian Networks based on observed retention outcomes.

11. The system of claim 10, wherein the data processing subsystem comprises:
a data collection agent configured to gather customer data from multiple sources;
a data processing agent configured to transform raw data for analysis; and
a data quality agent configured to validate data quality through multiple tests.

12. The system of claim 10, wherein the churn prediction subsystem comprises:
an automatic custom churn modeling agent configured to select and train machine learning models for churn prediction; and
a custom churn explainability agent configured to generate local and global explanations for churn predictions.

13. The system of claim 10, wherein the churn timeline subsystem comprises a customer survival analysis agent configured to generate and apply Kaplan-Meier estimators to predict when customers are likely to churn.

14. The system of claim 10, wherein the retention planning subsystem comprises:
a customer differential diagnosis agent configured to construct Bayesian Networks representing relationships between churn causes and treatments;
a customer churn shift agent configured to update differential diagnoses based on new information; and
a customer treatment prescriber agent configured to map churn causes to appropriate treatments.

15. The system of claim 10, wherein the customer interaction subsystem comprises a customer interaction recommender agent configured to generate personalized communications using a specialized Large Language Model.

16. The system of claim 10, wherein the persistence subsystem comprises:
a phase 1 persistence agent configured to store churn prediction data and models;
a phase 2 precedence alarm agent configured to alert stakeholders about imminent churn risks; and
a persistence agent configured to store retention attempt outcomes and update system knowledge.

17. The system of claim 10, wherein the orchestration layer is further configured to prioritize retention interventions by combining a churn probability score from the churn prediction subsystem with a predicted churn timeline from the churn timeline subsystem to generate a ranked intervention queue ordered by urgency.

18. The system of claim 11, wherein the structured inter-agent communication protocol enables deterministic agent sequencing by requiring each agent to complete execution and return a schema-conformant response message before the orchestration layer dispatches the next task, thereby reducing inter-process communication errors and improving pipeline throughput without requiring centralized synchronization locks.

19. A non-transitory computer-readable storage medium storing instructions that, when executed by a computing system, cause the computing system to perform operations of an agentic artificial intelligence pipeline comprising an orchestration layer that coordinates a plurality of specialized AI agents via a schema-validated inter-agent communication protocol, the operations comprising:
collecting and processing customer data through specialized artificial intelligence (AI) agents;
predicting which customers are likely to churn and when using custom modeling agents;
determining causes of potential churn and appropriate treatments through differential diagnosis using a Bayesian Network;
generating personalized retention communications through a Large Language Model agent conditioned on identified churn causes and mapped treatments;
presenting retention recommendations for human verification and receiving operator approval, modification, or rejection of each recommendation prior to implementation;
implementing only approved retention actions; and
updating Bayesian Network conditional probability distributions based on observed retention outcomes to improve future retention recommendations.

20. The non-transitory computer-readable storage medium of claim 19, wherein updating retention strategies comprises computing updated conditional probability distributions for churn causes based on observed retention outcomes and adjusting treatment mappings within a Bayesian Network to increase the probability weight of treatments associated with successful retention outcomes.
